(19) United States
(12) Patent Application Publication
(10) Pub. No.: US 2012/0081419 A1
(43) Pub. Date: Apr. 5, 2012

(54) IMAGE DISPLAY APPARATUS AND CONTROL METHOD THEREOF

(75) Inventor: Naoto Abe, Machida-shi (JP)

(73) Assignee: CANON KABUSHIKI KAISHA, Tokyo (JP)

(21) Appl. No.: 13/223,954

(22) Filed: Sep. 1, 2011

(30) Foreign Application Priority Data
Oct. 1, 2010 (JP) 2010-224191

(51) Int. Cl. G09G 3/36; G09G 5/10

(52) U.S. Cl. 345/691; 345/102

(57) ABSTRACT

An image display apparatus comprises: a liquid crystal panel; a backlight system divided into a plurality of blocks; and a control unit that controls emission of each block of the backlight system. The control unit analyzes an inputted video image signal and detects motion in a video image to be displayed at each of the portions of the display screen corresponding to each of the plurality of blocks, and controls emission time and emission intensity of each block in such a manner that in a block corresponding to a video image of little motion, the emission time is made relatively longer and the emission intensity is made relatively smaller, and in a block corresponding to a video image of significant motion, the emission time is made relatively shorter and the emission intensity is made relatively larger.

### BACKGROUND OF THE INVENTION

1. Field of the Invention

The present invention relates to an image display apparatus and a control method thereof, and more particularly, to a backlight control method in a liquid crystal display apparatus.

2. Description of the Related Art

Various methods have been proposed in order to improve the display quality of a liquid crystal display (LCD). For instance, Japanese Patent Application Laid-open No. 2008-096521 discloses the feature of inserting, between video image frames, black image frames having a black image signal level according to an interframe difference amount, in order to improve motion blur (hold blur) that is peculiar to hold-type displays, such as liquid crystal display apparatuses. Flicker may occur as a result of insertion of black image frames, and hence Japanese Patent Application Laid-open No. 2008-096521 discloses the feature reducing flicker by controlling backlight brightness to be high/low in accordance with a high/low level of a black image signal. Japanese Patent Application Laid-open No. 2007-322881 discloses a method that involves dividing a display region of a liquid crystal display apparatus into a plurality of blocks, and controlling the backlight emission brightness of each block, to reduce power consumption thereby. In Japanese Patent Application Laid-open No. 2007-322881, image flicker caused by brightness fluctuation between frames is reduced by using a non-linear conversion table for converting an image signal into a light source control value,

Black image frame insertion, such as the one disclosed in Japanese Patent Application Laid-open No. 2008-096521, is effective for realizing display similar to that of impulse display in a liquid crystal display apparatus, and for improving hold blur in video images where motion is significant. However, black image frame insertion entails unnecessary processing, and incurs negative effects, such as flicker, for those images where hold blur is not problematic in the first place, as in video images where there is virtually no motion. One video image frame often contains objects that move in various ways, from objects that do not move to objects of significant motion. However, it is difficult to achieve both hold blur improvement and flicker reduction in such video images in accordance using conventional methods.

Studies by the inventor have revealed that some video images are not suitable for impulse-type display from among video images where motion is significant. For instance, object motion continuity fails to be perceived visually such that the objects are seen as appearing and disappearing at random positions when black image frames are inserted in video images where objects move in various directions at various velocities. This kind of disturbance is referred to as randomness feel in the present description. Such randomness feel cannot be avoided in conventional methods.

### SUMMARY OF THE INVENTION

In the light of the above, it is an object of the present invention to further improve display quality upon display of a moving video image in a liquid crystal display apparatus.

The present invention in its first aspect provides an image display apparatus, including: a liquid crystal panel; a backlight system divided into a plurality of blocks relating to portions of a display screen of the liquid crystal panel, respectively; and a control unit that controls light emission of each block of the backlight system, wherein the control unit: analyzes an inputted video image signal and detects motion in a video image to be displayed at each of the portions of the display screen corresponding to each of the plurality of blocks; and controls emission time and emission intensity of each block in such a manner that in a block corresponding to a video image of little motion, the emission time is made relatively longer and the emission intensity is made relatively smaller, and in a block corresponding to a video image of significant motion, the emission time is made relatively shorter and the emission intensity is made relatively larger.

The present invention in its second aspect provides an image display apparatus, including: a liquid crystal panel; a backlight system divided into a plurality of blocks relating to portions of a display screen of the liquid crystal panel, respectively; and a control unit that controls light emission of each block of the backlight system, wherein the control unit analyzes an inputted video image signal and detects motion in a video image to be displayed at each of the portions of the display screen corresponding to each of the plurality of blocks, and controls emission time of each block in such a manner that the emission time in a block corresponding to a video image in which motion of uniform velocity or uniform acceleration is detected is made relatively shorter, and the emission time in a block corresponding to a video image in which motion other than the motion of uniform velocity or uniform acceleration is detected is made relatively longer.

The present invention in its third aspect provides a control method of an image display apparatus provided with a liquid crystal panel, and a backlight system with light emission, divided into a plurality of blocks mapped to portions of a display screen of the liquid crystal panel, respectively, the method including the steps of: analyzing an inputted video image signal, and detecting motion in a video image to be displayed at each of the portions of the display screen corresponding to each of the plurality of blocks; and controlling emission time and emission intensity of each block in such a manner that in a block corresponding to a video image of little motion, the emission time is made relatively longer and the emission intensity is made relatively smaller, and in a block corresponding to a video image of significant motion, the emission time is made relatively shorter and the emission intensity is made relatively larger.

The present invention in its fourth aspect provides a control method of an image display apparatus provided with a liquid crystal panel, and a backlight system with light emission, divided into a plurality of blocks relating to portions of a display screen of the liquid crystal panel, respectively, the method including the steps of: analyzing an inputted video image signal, and detecting motion in a video image to be displayed at each of the portions of the display screen corresponding to each of the plurality of blocks; and controlling emission time of each block in such a manner that the emission time in a block corresponding to a video image in which motion of uniform velocity or uniform acceleration is detected is made relatively shorter, and the emission time in a block corresponding to a video image in which motion other than the motion of uniform velocity or uniform acceleration is detected is made relatively longer.

According to the present invention, display quality upon display of a moving video image in a liquid crystal display apparatus can be further improved.

Further features of the present invention will become apparent from the following description of exemplary embodiments with reference to the attached drawings.

### BRIEF DESCRIPTION OF THE DRAWINGS

FIG. 1A is a block diagram of an image display apparatus of a first embodiment of the present invention, FIG. 1B shows blocks of a backlight system;

FIG. 2 is a block diagram of an image display apparatus of a second embodiment of the present invention;

FIG. 3 is a block diagram of an image display apparatus of a third embodiment of the present invention;

FIG. 4 is a block diagram of an image display apparatus of a fourth embodiment of the present invention;

FIG. 5 is a schematic diagram for explaining the configuration of an AM-LCD;

FIG. 6 is a timing diagram for explaining the operation of an AM-LCD;

FIGS. 7A to 7C are timing diagrams for explaining the lighting operation of an AM-LCD;

FIGS. 8A to 8C are graphs illustrating examples of characteristics wherein emission time is calculated on the basis of the output of a motion detection unit;

FIG. 9 is a diagram illustrating an appropriate relationship between backlight emission time and emission intensity;

FIGS. 10A and 10B are diagrams illustrating schematically examples of an emission time calculation unit;

FIG. 11A is a diagram for explaining evaluation of uniform velocity movement, and FIG. 11B is a diagram for explaining evaluation of uniform acceleration movement;

FIGS. 12A to 12C are graphs illustrating examples of characteristics of backlight emission time with respect to an offset coefficient K;

FIG. 13 is a diagram illustrating schematically the configuration of an emission time calculation unit that performs evaluation of uniform velocity;

FIGS. 14A to 14C are graphs illustrating examples of characteristics of backlight emission time with respect to an offset coefficient L;

FIG. 15 is a diagram illustrating the configuration of an emission time calculation unit that performs evaluation of uniform acceleration;

FIG. 16A is a diagram illustrating schematically a moving subject, and FIG. 16B is a diagram illustrating emission time for each block;

FIGS. 17A to 17C are graphs illustrating examples of a relationship between weightings V1 and V2 and emission time; and

FIGS. 18A to 18C are graphs illustrating examples of a characteristic of backlight emission time with respect to APL.

### DESCRIPTION OF THE EMBODIMENTS

The present invention can be appropriately used in a transmissive or reflective liquid crystal display apparatus (LCD) that has a backlight therein. Embodiments of the present invention will be explained based on a transmissive LCD that is directly viewed by an observer, but the present invention can be suitably used also in transmissive or reflective LCDs for projection onto a screen or the like.

(LCD Principles)

An outline of the operating principles of an LCD suitable for the present invention will be explained first. LCDs can be classified broadly into active matrix types and passive matrix types. The embodiments below will be explained for active matrix types, which are widely used at present in TV sets, PC monitors and the like. However, the present invention can be used also in passive matrix LCDs.

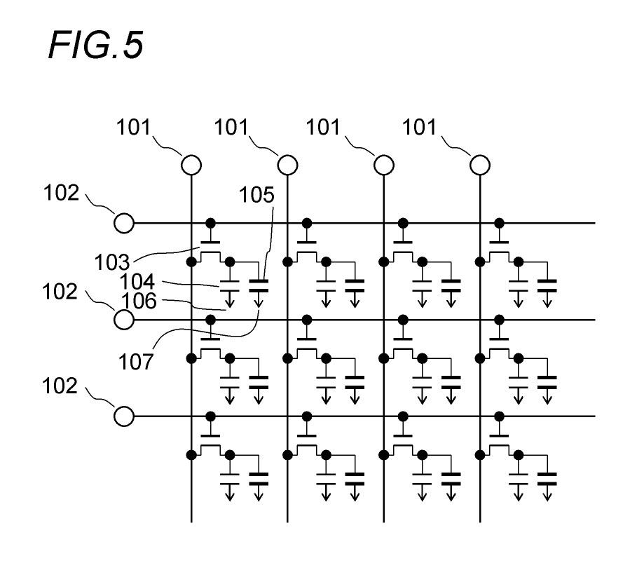

FIG. 5 illustrates schematically the configuration of a part of a liquid crystal panel of an active matrix LCD (AM-LCD). In FIG. 5, the reference numeral 101 denotes source wiring, the reference numeral 102 denotes gate wiring, the reference numeral 103 denotes a thin film transistor formed at each display element, the reference numeral 104 denotes a capacitor formed at each display element, and the reference numeral 105 denotes a liquid crystal formed at each display element. The arrows 106 and 107 denote wirings from electrodes of the capacitor 104 and the liquid crystal 105. The wirings 106, 107 are connected to counterelectrodes not shown. The number of source wirings 101 and gate wirings 102 in FIG. 5 corresponds to the number of required pixels in the display apparatus. For the sake of a simpler explanation, an example will be explained in which the display apparatus has 240×320 pixels. In a 240×320 pixel display apparatus, the number of source wirings 101 is 960 (320×3 (RGB)), and the number of gate wirings 102 is 240.

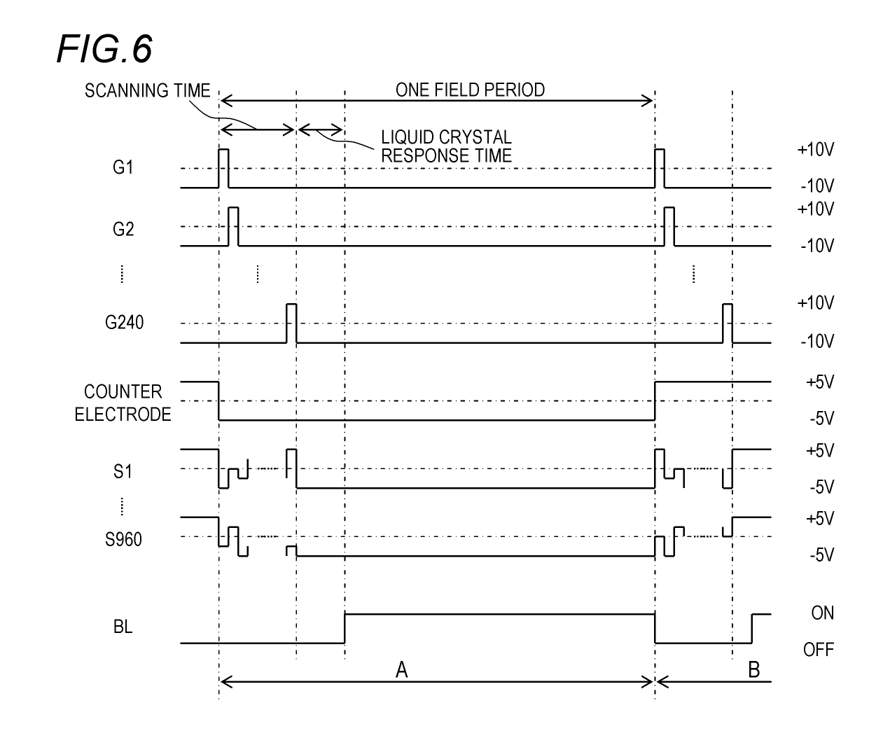

The operation of the AM-LCD illustrated in FIG. 5 will be explained next based on the timing diagram of FIG. 6. In FIG. 6, the abscissa axis represents time and the ordinate axis represents schematically voltage or emission intensity. The waveforms G1, G2, . . . G240 in FIG. 6 as voltages applied to the gate wirings 102, are signals for scanning the voltage that is applied to the liquid crystal 105. In FIG. 6, the waveforms S1, . . . S960 are the voltages applied to the source wirings 101. When the voltage applied to the gate wirings 102 is, for instance, +10V, the channel of the thin film transistor 103 formed in each display element becomes conductive, and the voltage of the source wirings 101 is applied to the corresponding capacitor 104 and liquid crystal 105 of the display element. The channel of the thin film transistor 103 is brought to a non-conducting state, and the voltage between the capacitor 104 and the liquid crystal 105 is held, when the voltage applied to the gate wiring 102 changes, for instance, from +10V to −10V. The voltage applied to the gate wiring 102 is sequentially scanned, for instance, from the top to the bottom of the display screen, such that the voltage of a corresponding source wiring 101 is controlled to a desired voltage. As a result, the voltage at sites where there is a difference between the voltage of the corresponding source wiring 101 and the voltage of the counterelectrode, is charged to, and held in, the capacitor 104 and the liquid crystal 105 that are formed at each of the corresponding display elements. Transmittance becomes defined, in the liquid crystal 105 (and polarizers not shown) to which a desired voltage is applied, after the response time of the liquid crystal. The brightness of light emitted by the backlight is modulated by the transmittance of the liquid crystal 105 (and polarizers not shown) defined for each display element, and an image is formed.

The backlight may be lit at all times, but, preferably, the backlight is lighted during the interval from after the response time of the liquid crystal 105 until application of gate voltage to the gate wiring 102 in the next field, as indicated by the waveform BL in FIG. 6. Doing so allows omitting display at a time where transmittance of the liquid crystal 105 (and polarizers not shown) is not defined. Image quality is improved as a result.

Continued application of DC voltage to the liquid crystal itself results in deterioration and burn-in of the liquid crystal substance. Driving is performed so as to reverse periodically the polarity of the voltage that is applied to the liquid crystal, in order to avert such deterioration and burn-in. In the field denoted by A in FIG. 6, the voltage of the source wirings 101 ranges from −5 V to +5 V, and the counterelectrode voltage is −5 V. In the field denoted by B, the voltage of the source wirings 101 ranges from +5 V to −5 V, and the counterelectrode voltage is +5 V. As a result, the voltage applied to the liquid crystal is reversed at each field. Inversion drive methods include line unit methods and dot unit methods, but a detailed explanation of the foregoing will be omitted, since the inversion drive method does not affect the fundamental features of the present invention.

(Backlight)

No display can be performed, at a time where the transmittance of the liquid crystal 105 (and the polarizers not shown) is not defined upon lighting of the backlight only during the interval from after the response time of the liquid crystal 105 until application of gate voltage to the gate wiring 102 in the next field, as indicated by the BL waveform in FIG. 6. Image quality is enhanced as a result. The scanning time for the period of one field is short in display apparatuses having a small number of display elements, and hence this kind of backlight control is possible in such display apparatuses. In display apparatuses having a large number of display elements, however, the scanning time must be longer. The backlight emission time becomes shorter, and brightness drops, in a display apparatus having the backlight control scheme of FIG. 6.

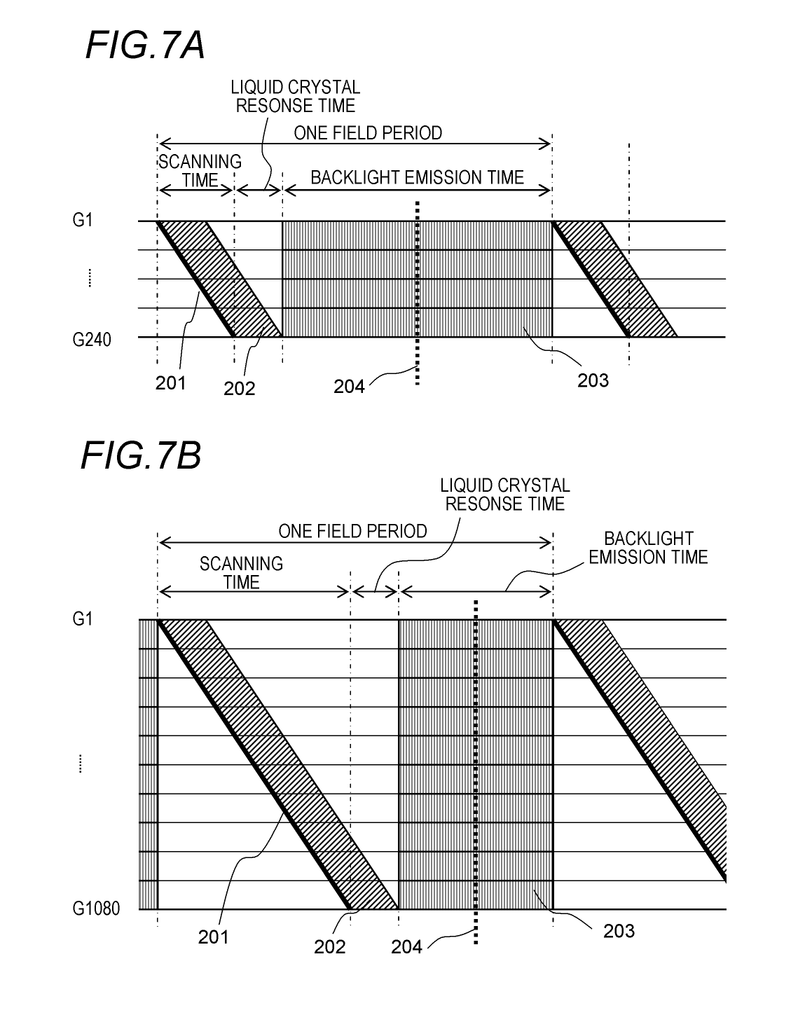

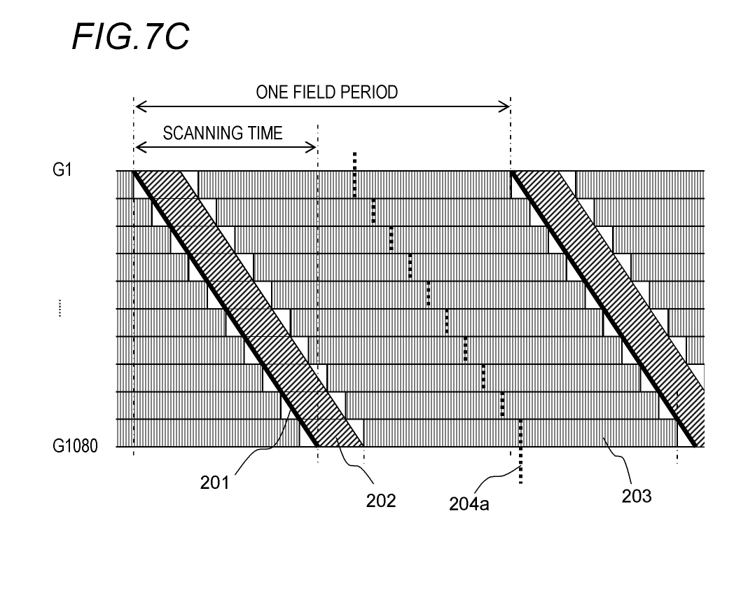

Further features are explained based on a description of FIG. 7A and FIG. 7B. In FIG. 7A and FIG. 7B, the abscissa axis denotes time and the ordinate axis denotes gate wiring. The bold line 201 denotes a point in time at which a selection potential is applied. The portion denoted by the oblique hatching 202 represents the response time of the liquid crystal, and the vertically hatched portion 203 represents the backlight emission time. The dotted line 204 represents a time centroid (center in the time axis direction) of emission time weighted by the emission intensity of the light source of the backlight.

FIG. 7A is a display apparatus having the same number of display elements (number of gate wirings) as in FIG. 6. FIG. 7B is an example of a display apparatus having a number of display elements, for instance, as in full HD, such that the number of gate wirings is 1080, and the scanning time required for applying a selection potential to all gate wirings is very long. Therefore, the backlight emission time indicated by the reference numeral 203 is shortened, and brightness drops. The method illustrated in FIG. 7C is performed to counter the shortening of the backlight emission time and to reduce brightness. The reference numerals 201 to 203 in FIG. 7C have the same meaning as above. The dotted line 204a represents a time centroid (center in the time axis direction) of emission time weighted by the emission intensity of the light source of the backlight.

Although not shown in the figures, an LCD that is driven according to the timing diagram of FIG. 7C has the backlight divided into 10 blocks in the scanning direction (vertical direction), in such a manner that the emission time of each block can be controlled. Lighting of the backlight is controlled individually, after a required response time of the liquid crystal has elapsed, for each of the 10 blocks. As illustrated in FIG. 7C, lighting of the backlight starts after the response time of the liquid crystal has elapsed, for each block, and the backlight is extinguished immediately before the scanning period of the next field, as a result of which the backlight emission time can be lengthened vis-à-vis that in FIG. 7B. The time centroid 204a of the emission time weighted by the emission intensity of the light source of the backlight is different for each block.

(Sample-and-Hold Blur)

The problem of hold blur in AM-LCDs is explained next. Sample-and-hold blur occurs when a subject moving on the screen is visually tracked. Herein, visual tracking denotes the feature of observing of the moving subject as the line of sight tracks the motion of the subject.

In impulse display in, for instance, CRTs, line-sequential driven FEDs or SEDs (surface-conduction electron-emitter displays) and the like, the display time (emission time) for each frame (or field) is very short. Accordingly, no blur occurs upon visual tracking of a moving subject.

In hold-type displays such as AM-LCD, by contrast, emission intensity is maintained over the duration of one frame. Upon visual tracking of a moving subject, as a result, an image of the subject, expanded in the motion direction, is formed on the retina. This is perceived as hold blur. Sample-and-hold blur occurs inevitably in hold-type displays upon visual tracking of moving objects. In order to avoid such hold blur upon display of moving subjects in hold-type displays, it is preferable to perform control so as to shorten the backlight emission time, and perform display as in impulse display.

In the case of video images where a moving subject cannot be visually tracked in a clear manner, on the other hand, the observer cannot visually perceive the continuity of subject motion, and perceives an unnatural display as if the subject appears and disappears at random positions (randomness feel), in the case of impulse display. When the same video image is displayed in hold-type display, the motion of the subject is blurred, and hence a video image can be viewed that has little such unnaturalness. Video images that are difficult to track visually include, for instance, video images of waterfalls and fountains. Droplets in waterfalls and fountains scatter in multiple directions at various velocities, and hence cannot be visually tracked. Motion cannot be predicted, and visual tracking is thus difficult, in motions that involve multiple directions and velocities, even for one single subject or a limited number of subjects.

(Blur at the Time of Imaging)

Blur at the time of imaging is explained next. Blur at the time of imaging occurs when a subject, which is the object to be captured within the imaging time of the imaging element, is moving. This blur is referred to also as motion blur. Methods for reducing blur at the time of imaging, involve, for instance, capturing the subject at an imaging time that is shorter than the frame time, through control of an electronic shutter or imaging plate.

When viewed in impulse display, subjects captured over a short imaging time using such an electronic shutter are perceived clearly, as visually trackable subjects free of blur.

On the other hand, randomness feel occurs upon display, in impulse display, of video images wherein a subject that is difficult to track visually is captured over a short imaging time. The inventor addressed the above problems, and found that the randomness feel can be eliminated by setting a longer imaging time, and by performing imaging by deliberately imparting blur at the time of imaging. The inventor found that randomness feel can be reduced, even when a subject that is difficult to track visually is captured over a short imaging time, by adding a low-frequency component, corresponding to the blur at the time of imaging, to the video image signal itself, by signal processing, and by performing display in which hold blur occurs.

(Flicker)

The problem of flicker occurs often in impulse display when the display frame rate is low. Brightness changes little in the time direction, even for a same frame rate, in hold-type display. Therefore, disturbances caused by flicker are smaller than in impulse display. However, flicker may occur also in hold-type display when the backlight emission time is shortened and there is provided a non-emission time between consecutive frames.

### First Embodiment

The present invention illustrates a method for reducing, for instance, the above-described disturbances of hold blur and flicker, by optimally controlling a video image signal and the backlight of an AM-LCD, which is a hold-type display.

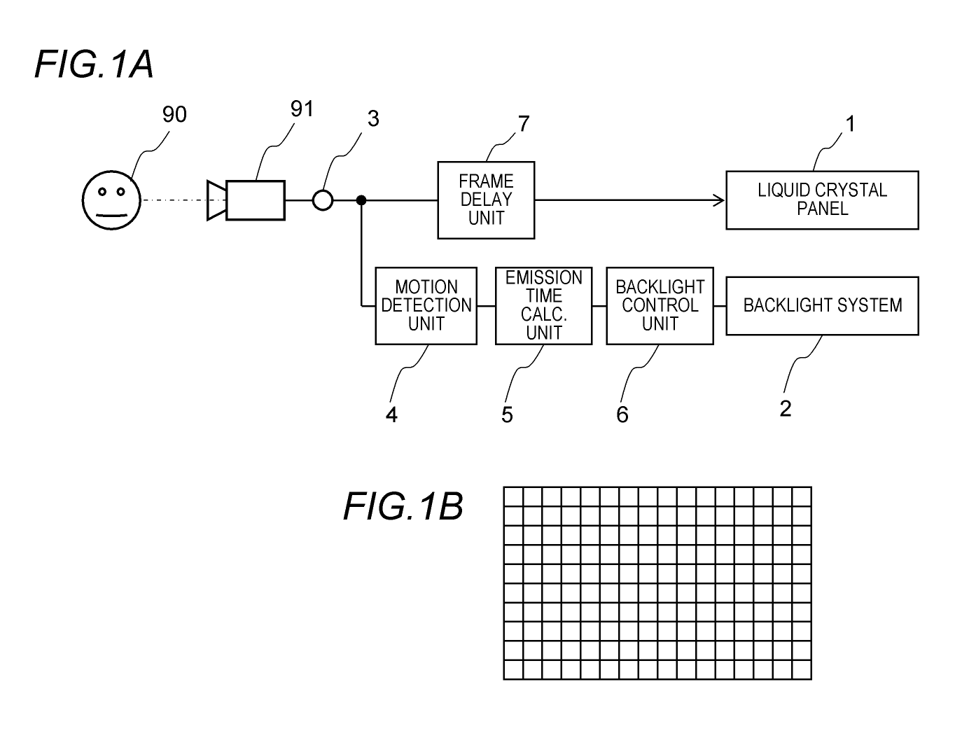

FIG. 1A illustrates a block diagram of the main portion of an image display apparatus of the first embodiment of the present invention.

In FIG. 1A, the reference numeral 1 denotes for instance the liquid crystal panel illustrated in FIG. 5, and the reference numeral 2 denotes a backlight system disposed at the rear of the liquid crystal panel 1 and that uses for instance a light-emitting diode (LED) as a light source. As illustrated in FIG. 1B, the backlight system 2 is divided into a plurality of blocks. The emission (emission intensity, emission time and so forth) of each block can be controlled independently. The display screen of the liquid crystal panel 1 is likewise divided into a plurality of portions, so that the each portion of the liquid crystal panel 1 is mapped to a respective block of the backlight system 2. The reference numeral 3 denotes a video image input terminal, and the reference numeral 4 is a motion detection unit that analyzes a video image signal and detects motion in a video image that is displayed at each portion, in a display screen, corresponding to each respective block. The reference numeral 5 denotes emission time calculation unit that calculates emission time and emission intensity for each block of the backlight system 2 on the basis of the output of the motion detection unit 4. The reference numeral 6 denotes a backlight control unit that controls LED emission time and emission intensity for each block, on the basis of the output of the emission time calculation unit 5. In the present embodiment, the motion detection unit 4, the emission time calculation unit 5 and the backlight control unit 6 make up a control unit that controls emission of each block of the backlight system 2. The reference numeral 7 denotes a frame delay unit that delays a video image signal by a time corresponding to the processing by the motion detection unit 4 and the emission time calculation unit 5. The reference numeral 90 denotes a subject, as a subject to be captured, and the reference numeral 91 denotes a video camera that captures the subject.

In the configuration of FIG. 1A, a video image output from the video camera 91 that captures the subject 90 is inputted to the video image input terminal 3 of the image display apparatus. The motion detection unit 4 calculates for each block a motion vector, in one-frame units, of the video image signal that is inputted to the video image input terminal 3.

The motion detection unit 4 performs for instance motion vector computation processing as described below. A respective motion vector detection unit area is set for the frame currently inputted (current frame) and the one precedent frame (previous frame). The motion detection unit 4 works out a correlation value between the video image of the previous frame and the video image of the current frame while displacing the motion vector detection unit area of the previous frame over a predetermined search range. A displacement amount having a high correlation value is decided as a motion vector of the motion vector detection unit area. This processing is performed for each of the plurality of motion vector detection unit areas in the current frame. The motion vector is a distance that denotes how the motion vector detection unit area moves in the time of one frame, and is expressed by coordinates (x, y).

The size of the motion vector detection unit area may be identical to, or dissimilar from, the size of the blocks of the light source of the backlight system 2. The average of the motion vector calculated for each motion vector detected within a block may be used as the motion vector of each block in a case where there is detected a motion vector, for each motion vector detection unit area smaller than the size of the blocks of the light source. In a case where, on the other hand, there is detected a motion vector for each motion vector detection unit area of size greater than the size of the blocks of the light source, a block unit motion vector may be worked out by applying a spatial low-pass filter to the motion vector calculated for each motion vector detection unit area. Performing computations after having reduced the number of pixels beforehand, by thinning or averaging, is an appropriate way of reducing the computational load of the motion vectors of the motion detection unit 4.

The motion vector for each block as worked out by the motion detection unit 4 in accordance with processing such as the above-described one is inputted to the emission time calculation unit 5. On the basis of the inputted motion vector for each block, the emission time calculation unit 5 outputs, for each block, data for controlling the emission time and emission intensity of the backlight that comprises a light source such as an LED or the like. The specific operation of the emission time calculation unit 5 is described further on.

The backlight control unit 6 controls the emission time and emission intensity of alight source such as an LED for each block, in accordance with the output of the emission time calculation unit 5. The backlight control unit 6 may be made up of a circuit for analog control of the emission intensity of an LED on the basis of negative feedback using an operational amplifier, or may be configured out of circuit that controls emission intensity by applying PWM modulation over a period shorter than the time of one frame. A configuration relying on PWM control is advantageous in terms of smaller power loss as compared with analog control.

As illustrated in FIG. 1B, the backlight system 2 is divided into a plurality of blocks, such that the emission intensity and the emission time of the LED within each block can be controlled independently. FIG. 1B illustrates an example in which an LCD panel comprising 1920 pixels×1080 pixels is divided into 160 blocks, namely 10 vertical×16 horizontal blocks. The number of divisions affects the number of LEDs and the number of backlight control units 6, and hence is decided in terms of striking a balance between cost and image quality. For instance, a great number of divisions such as vertical 18×horizontal 32 incurs a higher cost but enables very fine control, which translates into better image quality.

In FIG. 1A, the frame delay unit 7, which comprises a frame memory, delays the video image signal that is outputted to the liquid crystal panel 1. An appropriate amount of delay is such that conforms to the lag time of backlight control on account of the computation time by the motion detection unit 4 and the emission time calculation unit 5. The frame delay unit 7 requires a frame memory, and is hence comparatively costly on account of the great amount of hardware involved. If the frame delay unit 7 is omitted, a temporal offset occurs with respect to display in the liquid crystal panel 1 and with respect to light emission in the backlight system 2. This offset gives rise to little discomfort in ordinary video images. Accordingly, the frame delay unit 7 may be omitted in order to reduce costs. The transmittance of each pixel is set in the liquid crystal panel 1 on the basis of the video image signal that is inputted, as described above. Although not shown in the figures, information on the emission time and emission intensity of each block as calculated by the emission time calculation unit 5 is inputted also to the liquid crystal panel 1. This information is used, as the case may require, for controlling the transmittance of the pixels of each block in the liquid crystal panel 1.

(Backlight Control Method)

The concept for backlight control in the present embodiment is explained next, followed by a description of the configuration and operation of the emission time calculation unit 5.

Upon display of a static subject, as described above, no hold blur occurs, and hence control so as to shorten the backlight emission time is not performed. Flicker can be reduced as a result.

By contrast, hold blur occurs in hold-type display, as described above, upon display of a moving subject. In the first backlight control method of the present embodiment, therefore, presence or absence of motion is detected for each block, and backlight emission time is controlled, to prevent hold blur.

As described above, a disturbance referred to as randomness feel occurs upon display, in the manner of impulse display, of a video image that contains subjects that are difficult to track visually. In the second backlight control method of the present embodiment, therefore, it is evaluated whether visual tracking is possible for each block and control is performed so as to shorten the backlight emission time only if visual tracking is possible, so that display is performed as in impulse display.

In the above approach, each block is irradiated at an optimal backlight emission time, as a result of which hold blur can be reduced for blocks of moving portions, while preventing flicker in blocks at portions where no motion is detected (stationary portions). Performing the second backlight control method allows further suppressing the occurrence of randomness feel in subjects that cannot be visually tracked, even for blocks with motion.

(First Backlight Control Method)

The first backlight control method is a method in which, on the basis of the motion detection results for each block, there is realized flicker-free display through prolongation of the emission time of blocks corresponding to video images having little motion, and occurrence of hold blur is suppressed through shortening of the emission time in blocks corresponding to video images where motion is significant.

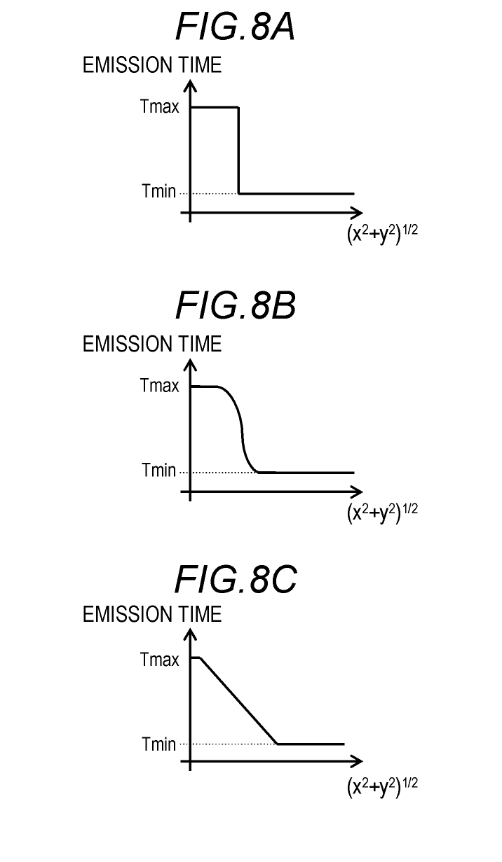

The motion vector for each block as worked out by the motion detection unit 4 is the displacement amount of the subject per unit frame, and denotes the displacement velocity of the subject. In the first backlight control method, the motion vector, which is the output of the motion detection unit 4, is evaluated, and the emission time is controlled, to reduce thereby hold blur. FIGS. 8A, 8B, 8C illustrate graphs of examples of conversion in which emission time is calculated on the basis of motion vectors for each block as worked out by the motion detection unit 4. The abscissa axis in FIGS. 8A, 8B, 8C represents the magnitude ((x²+y²)^{1/2}) of the motion obtained from the motion vector, as the output of the motion detection unit 4, and the ordinate axis represents the backlight emission time, which is the output of the emission time calculation unit 5. In FIGS. 8A, 8B, 8C, hold blur is reduced by performing control so as to shorten the emission time when motion is significant. In all conversion methods, the time is set to a longest emission time Tmax (first emission time) in a case where the magnitude of motion is zero (no motion at all), and to a shortest emission time Tmin (second emission time) when the magnitude of motion is greater than a threshold. Between Tmax and Tmin, the emission time decreases monotonically, stepwise or continuously, in accordance with the magnitude of motion. The conversion in FIG. 8A is a two-stage switching method such that the emission time is set to a first emission time Tmax when the magnitude of motion is equal to or smaller than a threshold, and to a short second emission time Tmin when the magnitude of motion is greater than the threshold. This method is effective in reducing hold blur, but may give rise to discomfort upon emission time switching. Accordingly, a preferable scheme involves controlling the emission time continuously in response to the magnitude of motion, as illustrated in FIGS. 8B, C. FIGS. 8A, 8B, 8C are mere examples, and for instance the emission time may be shortened from Tmax to Tmin over a plurality of stages.

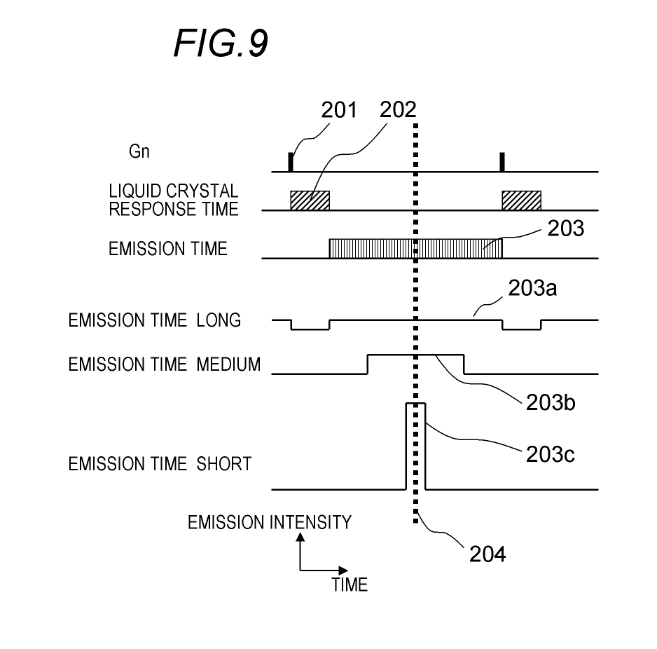

An explanation follows next on a method for controlling emission intensity accompanying control of the emission time. FIG. 9 is a timing diagram illustrating the relationship between emission time and emission intensity. In FIG. 9, the reference numeral 201 denotes selection potential of gate wiring, the oblique hatching 202 denotes the liquid crystal response time, the vertical hatching 203 denotes the backlight emission time, and the dotted line 204 denotes the time centroid of the emission time weighted by the emission intensity of the light source of the backlight. The reference numerals 203, 203a, 203b, 203c in the ordinate axis denote emission intensity. The reference numerals 203, 203a, 203b, 203c are emission times for different frames in one same block, but in FIG. 9 have been lined up in one same time axis for comparison purposes.

In the present embodiment, as illustrated in FIG. 9, the emission intensity of the light source is controlled in such a manner that the brightness (brightness perceived by an observer) does not change depending on the length of emission time. That is, control is performed in such a manner that emission intensity is lowered when the emission time is long (203a), and is raised when the emission time is short (203c), and in such a manner that the brightness does not vary depending on the emission time. In a hypothetical case where the emission intensity and brightness are proportional, the emission intensity may be controlled in such a manner that the time integrations of the emission intensity (surface area of the waveforms 203a, 203b, 203c of FIG. 9) are identical to each other.

The emission time is controlled in such a manner that the position (timing) of the time centroid 204 of the emission time weighted by the emission intensity of the light source of the backlight does not vary between frames. In a case where, as illustrated in FIG. 9, the emission intensity is constant within the emission time, the timing of emission start and emission end may be simply decided in such a manner that the center of the emission time does not vary. The reasons for avoiding changes in the time centroid 204 are as follows. Occurrence of changes in the time centroid 204 for each frame is equivalent to occurrence of imbalances in a frame display (emission) interval. For instance, the motion of the subject is perceived as unnatural, and motion blur can be observed, when respective frames of a video image in which a subject moves at uniform velocity are displayed at unequal intervals. This problem arises because the displacement of the line of sight (predicted position) of the observer and the display position of the subject are offset from each other, as a result of which variability in the image-formation position occurs on the retina of the observer. Therefore, emission time is controlled in such a way so as to preclude changes in the time centroid 204 (i.e. in such a manner that the time centroid 204 stays the same for all frames), as illustrated in FIG. 9. The occurrence of unnatural motion and blur can be prevented as a result. The position of the time centroid may vary for each block, as illustrated in FIG. 7C. In this case as well, the emission time of each block is controlled in such a manner that the time centroid of the emission time does not change with respect to a position established beforehand for each block. The occurrence of unnatural motion and blur can be prevented as a result.

(Emission Time Calculation Unit in the First Backlight Control Method)

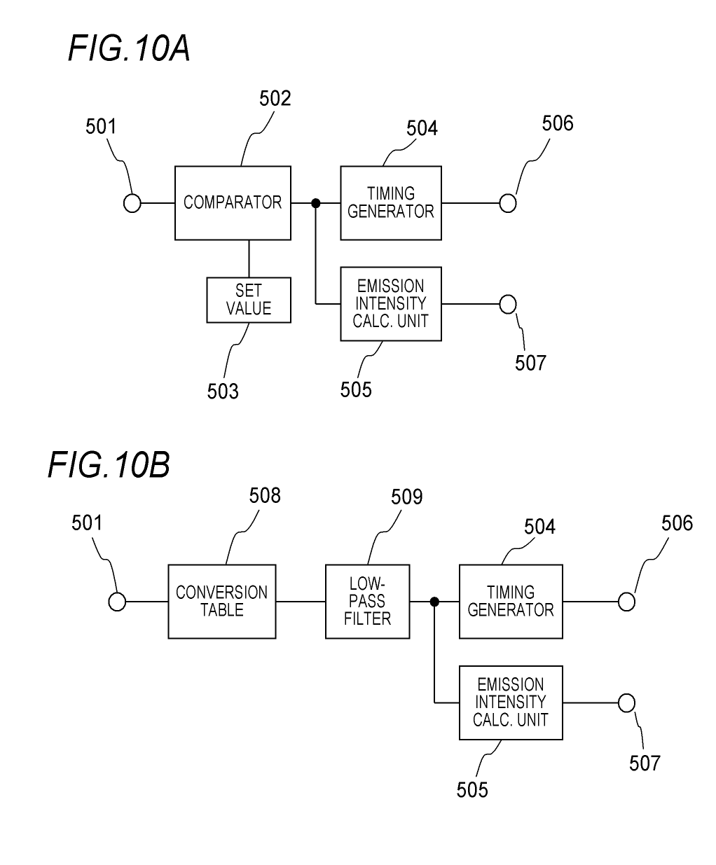

FIGS. 10A, 10B illustrate suitable configuration examples of the emission time calculation unit 5.

The configuration of FIG. 10A will be explained first. In FIG. 10A, the reference numeral 501 is an input terminal through which there is inputted the motion vector that is the output of the motion detection unit 4, the reference numeral 502 is a comparator that compares the magnitude of the motion vector with a set value, and the reference numeral 503 is a register that stores a set value (threshold). The reference numeral 504 is a timing generator that generates emission timing on the basis of the emission time, which is the output of the comparator 502. The reference numeral 505 is an emission intensity calculation unit that decides the emission intensity on the basis of the emission time, which is the output of the comparator 502, as illustrated in FIG. 9. The reference numeral 506 is an output terminal that outputs the emission time of the backlight control unit 6. The reference numeral 507 is an output terminal that outputs a voltage, denoting the emission intensity, to the backlight control unit 6. Motion vectors, which are the output of the motion detection unit 4, are represented by coordinate values (x, y) that denote the amount of motion per one frame. The units of the coordinate values are pixels.

In FIG. 10A, the comparator 502 converts the motion vector to a magnitude of motion ((x²+y²)^{1/2}) per one frame, and compares the magnitude of the result with the set value of the register 503. If the magnitude of motion is greater than the set value, the comparator 502 outputs data on the short emission time Tmin, and if the magnitude of motion is equal to or smaller than the set value, the comparator 502 outputs data on the long emission time Tmax. The emission time, which is the output of the comparator 502, is inputted to the timing generator 504. The timing generator 504 decides the emission start timing in such a manner that the time centroid 204 does not shift, and outputs a timing signal, at emission start and emission end, through the output terminal 506. The emission intensity calculation unit 505 calculates the emission intensity in such a manner that brightness does not vary, regardless of the length of the emission time. For instance, the emission intensity calculation unit 505 may be appropriately configured in the form of a table that is implemented in a memory or the like. The calculated emission intensity is converted to voltage by a D/A converter, not shown, and is outputted.

The above features allow the emission time to be controlled on the basis of the motion vector detected by the motion detection unit 4, and allow reducing flicker in blocks of a stationary subject, and reducing hold blur in blocks of a moving subject.

The threshold (set value) illustrated in FIG. 8A may be obtained on the basis of a subjective evaluation of optimal values in accordance with the size and brightness of the display, and in accordance with the distance between an observer and the display. In the case of a full HD panel for television, the threshold (set value) may be appropriately set to 2 to 20 pixels/frame.

The emission time calculation unit 5 having the configuration illustrated in FIG. 10B will be explained next. In FIG. 10B, the portions denoted by the reference numerals 501, 504, 505, 506 and 507 are identical to those of FIG. 10A, and hence an explanation thereof will be omitted.

In FIG. 10B, the reference numeral 508 is a conversion table into which there is inputted a motion vector, as the output of the motion detection unit 4, and from which there is outputted the emission time. The reference numeral 509 is a low-pass filter that cuts, from the output of the conversion table 508, a high-frequency component in the time direction or the spatial direction, or in both directions.

As described above, the motion detection unit 4 outputs, as units, pixels according to coordinates (x, y) taking the motion vector as the amount of motion per one frame. The conversion table 508 is a table for converting the magnitude of motion per one frame ((x²+y²)^{1/2}) to emission time, as illustrated in FIGS. 8A, 8B, 8C. The motion vector is converted to a magnitude of motion per one frame ((x²+y²)^{1/2}), and is inputted to the conversion table 508. The conversion table 508 may be a table into which the magnitude of motion ((x²+y²)^{1/2}) is inputted, but also a table into which the motion vector (x, y) is inputted directly, such that the table outputs the emission time. In this case, hardware costs can be reduced, since there is omitted the computation for working out the magnitude of motion per one frame on the basis of the motion vector (x, y).

The emission time data, which is the output of the conversion table 508, may be inputted directly, as described above, into the timing generator 504 and the emission intensity calculation unit 505, but is more preferably inputted to the low-pass filter 509, as illustrated in FIG. 10B.

The low-pass filter 509 cuts the high-frequency component of the emission time data in the time direction or the spatial direction, on in both directions. Providing a low-pass filter 509 allows easing changes of emission time in the time direction and changes of emission time in the spatial direction (between blocks). As a result, this allows reducing the discomfort that arises on account of differences in the length of emission time between blocks and/or changes in the temporal length of the emission time. The emission time data, which is the output of the low-pass filter 509, is inputted to the timing generator 504 and the emission intensity calculation unit 505, where the emission time and the emission intensity are decided as described above.

By virtue of the above configuration, the emission time and the emission intensity are controlled on the basis of the magnitude of the motion vector as detected by the motion detection unit 4. As a result, flicker can be reduced in stationary-subject blocks and hold blur can be reduced in moving-subject blocks. The emission time can be continuously modified in accordance with the magnitude of motion, and changes of the emission time in the block direction and/or the time direction can be eased thanks to the low-pass filter. This allows reducing, as a result, discomfort caused by differences in length of emission time in each block.

(Second Backlight Control Method)

The second backlight control method is a method for preventing hold blur, wherein the backlight emission time is controlled by the evaluating the quality of motion for each block.

As described above, a disturbance referred to as randomness feel occurs, in impulse display, for subjects that cannot be visually tracked. In this disturbance, motion lacks continuity, and the subject appears and disappears randomly. As a result, display becomes yet more unnatural than in the case of hold blur that occurs in hold-type display.

The purpose of the second backlight control method is to improve this kind of unnatural display. Specifically, hold blur is improved by performing driving as in impulse display, for video images that can be visually tracked, and performing otherwise conventional driving, of hold-type display, on video images for which visual tracking is difficult, to suppress thereby randomness feel.

The motion of a subject that can be visually tracked will be described first, before moving onto the explanation of the second backlight control method. The inventor observed the motion of subjects that can be visually tracked, and found that subjects that move at uniform velocity, such as captions or tickers, or subjects that move at uniform acceleration can be satisfactorily tracked by the human eye.

Therefore, emission time in the backlight system is shortened, approaching that of impulse display driving, for subjects that move at uniform velocity or uniform acceleration. Sample-and-hold blur can be prevented as a result. Further, subjects that move at uniform velocity or uniform acceleration can be visually tracked, and hence no randomness feel occurs. Visual tracking is difficult for other kinds of motion, and hence the emission time of the backlight system is lengthened in such a way so as prevent randomness feel, and conventional driving of hold-type display is performed. As a result, hold blur still occurs, but the randomness feel can be suppressed.

(Uniform Velocity Evaluation)

An example of uniform velocity evaluation will be described first.

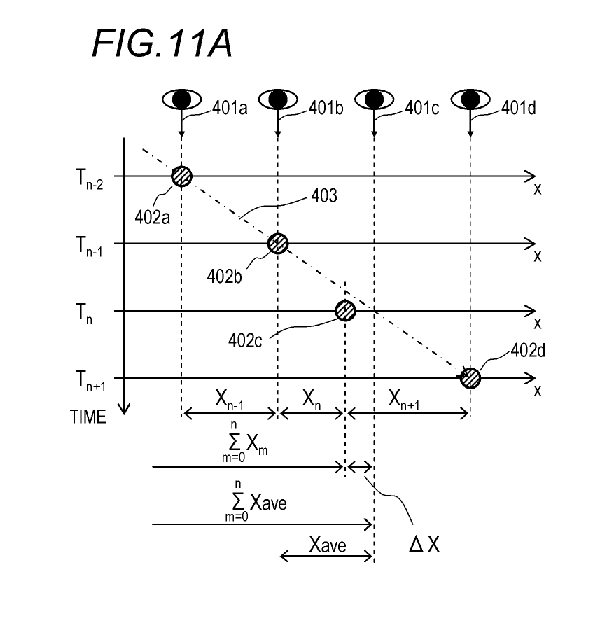

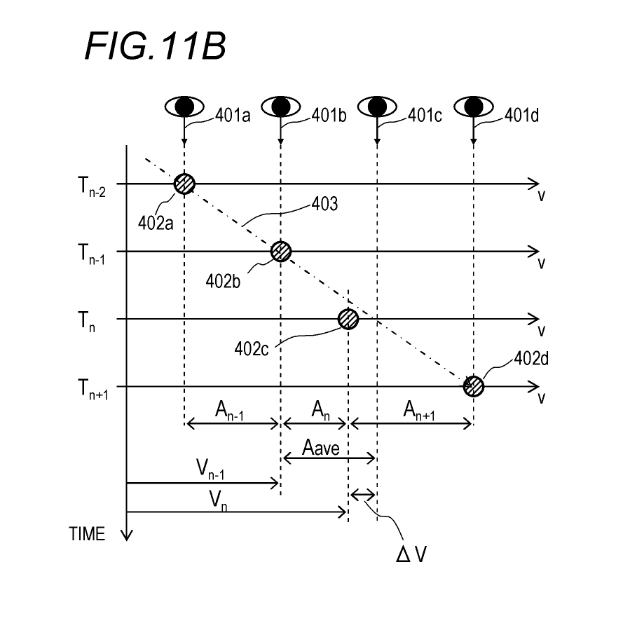

FIG. 11A is a graph for explaining evaluation of uniform velocity movement. In FIG. 11A, the ordinate axis represents points in time, and the abscissa axis represents position in the x direction. The ordinates Tₙ₋₂, Tₙ₋₁, Tₙ, Tₙ₊₁ denote points in time for each frame. In the explanation, the abscissa axis is the x direction, but evaluation may be suitably performed for positions in both the x and y axes. In FIG. 11A, the reference numerals 401a, 401b, 401c, 401d denote schematically the lines of sight of visual tracking at the respective points in time Tₙ₋₂, Tₙ₋₁, Tₙ, Tₙ₊₁. The reference numerals 402a, 402b, 402c, 402d denote the moving subject, which is moving at substantially uniform velocity. The observer cannot match the line of sight to the motion of the subject, for each frame. Instead, the observer tracks the average motion of the subject and shifts the line of sight at uniform velocity. That is, an offset (ΔX) with respect to the line of sight 401c arises for a subject, such as the subject 402c, that deviates from uniform velocity. This offset becomes a blur on the retina. In turn, this blur gives rise to randomness feel in impulse display.

The character of this blur is defined in the present description in the form of an “offset coefficient: K” as the ratio of the extent to which the subject is offset with respect to the line of sight of visual tracking at uniform velocity. Randomness feel is less likely to occur if this offset coefficient K takes on a small value. Accordingly, the backlight emission time is shortened, and there is performed display free of hold blur, close to that of impulse display.

The offset coefficient K for an n-th frame, at the current point in time, is defined based on Equation 1), wherein Xₘ is the displacement amount per one frame, at an m-th frame, obtained on the basis of the motion vector that is the output of the motion detection unit 4, and Xave is the average displacement amount per one frame in the line of sight of the observer.

$$K = \vert {\sum }_{m = 0}^{n} ( {X}_{m} ) - {\sum }_{m = 0}^{n} ( Xave ) \vert / \vert Xave \vert \qquad Equation 1 )$$

As illustrated in FIG. 11A the offset coefficient K is defined as the value resulting from dividing the difference (ΔX) between the position of the subject and the visual tracking position by the travel distance (Xave) of the line of sight per one frame.

For instance, no offset arises between the position of the line of sight and the position of the subject if the offset coefficient K is zero. Therefore, no randomness feel occurs even if the backlight emission time is shortened, as in impulse display. In the case of an offset coefficient K of 0.5 or greater, by contrast, the subject is offset by a distance that is half the distance traveled over one frame period during visual tracking. Disturbances start becoming conspicuous at such an offset coefficient. Therefore, the backlight emission time is controlled for each block in accordance with the value of the offset coefficient K for each block. Specifically, control is performed so as to shorten the backlight emission time, and reduce hold blur, for blocks that have a small offset coefficient K and can be visually tracked. On the other hand, control is performed so as to lengthen the backlight emission time, and suppress the occurrence of randomness feel, for blocks that have a large offset coefficient K and that may give rise to randomness feel upon visual tracking.

It is also appropriate to work out the offset coefficient K by using the following equation variants in order to further simplify the defining equation of the offset coefficient K. Specifically, Equation 1) can be transformed into

$$K = \vert \{ {\sum }_{m = 0}^{n - 1} ( {X}_{m} ) + {X}_{n} \} - \{ {\sum }_{m = 0}^{n - 1} ( Xave ) + Xave \} \vert / \vert Xave \vert \qquad Equation 2 )$$

We assume that visual tracking is possible, (i.e. there is no offset between the position of the line of sight and the position of the subject), up to before the current point in time n. This is expressed formally as

$${\sum }_{m = 0}^{n - 1} ( {X}_{m} ) = {\sum }_{m = 0}^{n - 1} ( Xave ) \qquad Equation 3 )$$

Substituting Equation 3) in Equation 2), we obtain

K=|Xₙ−Xave|/|Xave| Equation 4)

Using Equation 1) or Equation 2) is appropriate for obtaining the offset coefficient K and for determining whether or not visual tracking is possible.

The travel distance of the line of sight per one frame (velocity of the line of sight) is the average value of the travel distance of the subject per one frame prior to the current point in time n, and can be obtained as

$$Xave = {\sum }_{m = 0}^{n - 1} ( {X}_{m} ) / n \qquad Equation 5 )$$

In the present embodiment, Equation 5) is substituted into Equation 1) or Equation 4) to compute thereby the offset coefficient K, and the backlight emission time of each block is decided on the basis of the magnitude of the offset coefficient K. The initial point in time in Equation 5) may be computed, for instance, taking a past scene change as a reference point.

The denominator in Equation 1) and Equation 4) is zero when the Xave is zero in a block of a stationary subject. Visual tracking is possible when a subject is stationary, and hence Equation 1) and Equation 4) are not computed in this case, and there is outputted a small value as the K value (for instance, K=0).

These computations are easy to implement in case of software processing, but may require greater hardware resources if implemented in the form of hardware. In hardware implementation, therefore, the computation of Equation 5) may involve computing the travel distance of the line of sight (velocity of the line of sight) Xave through a computation (recursive filter) that is weighted based on the current point in time. Doing so allows reducing hardware requirements, and allows obtaining a value close to the velocity of actual visual tracking by the observer. The equation for obtaining Xaveₙ, which is the velocity of visual tracking during the frame at point in time n, is given by

Xaveₙ=S1·Xₙ₋₁+S2·Xaveₙ₋₁ Equation 6)

where

S1+S2=1 Equation 7)

The weighting of the velocity of the line of sight one frame earlier and the velocity of the subject one frame earlier can be modified using S1 and S2. Ordinarily, S1 and S2 are set in such a manner that S2 is greater than S1.

A computation such as the below-described one may be appropriately performed in order to compute the velocity of the line of sight in an easy manner. The computational load can be reduced if the velocity of the line of sight Xaveₙ in the frame at the point in time n is obtained on the basis of an average value of the velocities of the subject in the two immediately previous frames. Specifically,

Xaveₙ=(½)·Xₙ₋₂+(½)·Xₙ₋₁ Equation 8)

To further simplify the computation of the velocity of the line of sight, the velocity of the line of sight Xaveₙ in the frame at the point in time n may be obtained simply on the basis of the velocity of the subject in the immediately previous frame. Specifically,

Xaveₙ=Xₙ₋₁ Equation 9)

The computation of the velocity of the line of sight in Equation 8) and Equation 9) incurs some error, but is considerably advantageous in terms of the accompanying reduction in computational load, both in hardware and software.

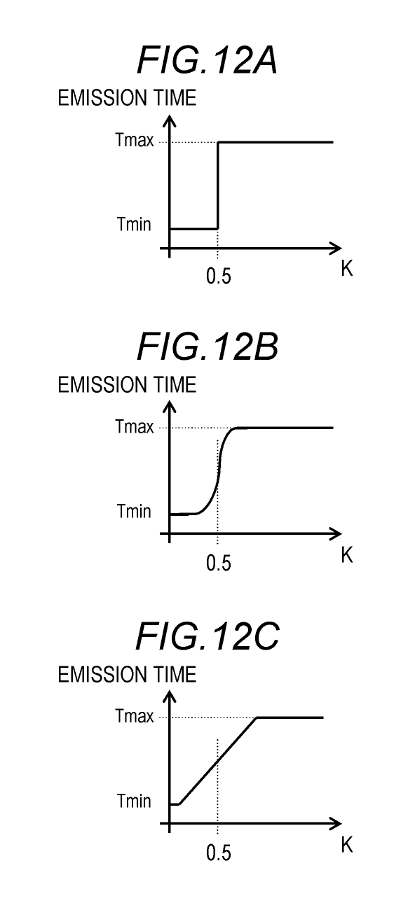

The offset coefficient K is computed by substituting Equation 5), Equation 6), Equation 8) or Equation 9) in Equation 1) or Equation 4), and the backlight emission time of each block is decided on the basis of the magnitude of the offset coefficient K, to control the backlight emission time. A large offset arises between the line of sight and the subject if the value of the offset coefficient K is large, and hence offset between the line of sight and the subject is small if the emission time is long and the offset coefficient K is small. Accordingly, the emission time is set to be shorter, to minimize hold blur. FIGS. 12A, 12B, 12C illustrate examples of the relationship between a preferred backlight emission time with respect to an offset coefficient K. In all the conversion methods, the emission time takes on a minimum value Tmin when uniform velocity movement is detected (when the offset coefficient K is zero or sufficiently small), and the emission time takes on a maximum value Tmax when motion is detected that is not uniform velocity movement (offset coefficient K of some magnitude). Between Tmin and Tmax, the emission time increases monotonically, stepwise or continuously, in accordance with the offset amount (value of the offset coefficient K) from uniform velocity movement. In the conversion table of FIG. 12A, a first emission time Tmax is selected if the offset coefficient K is greater than a predetermined threshold (for instance, 0.5), and a short second emission time Tmin is selected if the offset coefficient K is equal to or smaller than the threshold. Such a method allows suppressing the occurrence of randomness feel, but may give rise to some discomfort upon emission time switching. Therefore, a more appropriate method involves modifying the emission time continuously, in accordance with the offset amount, from uniform velocity movement, as illustrated in FIGS. 12B, 12C. Herein, FIGS. 12A, 12B, 12C are mere examples, and for instance the emission time may be lengthened from Tmin to Tmax over a plurality of stages.

(Emission Time Calculation Unit that Performs Evaluation Of Uniform Velocity)

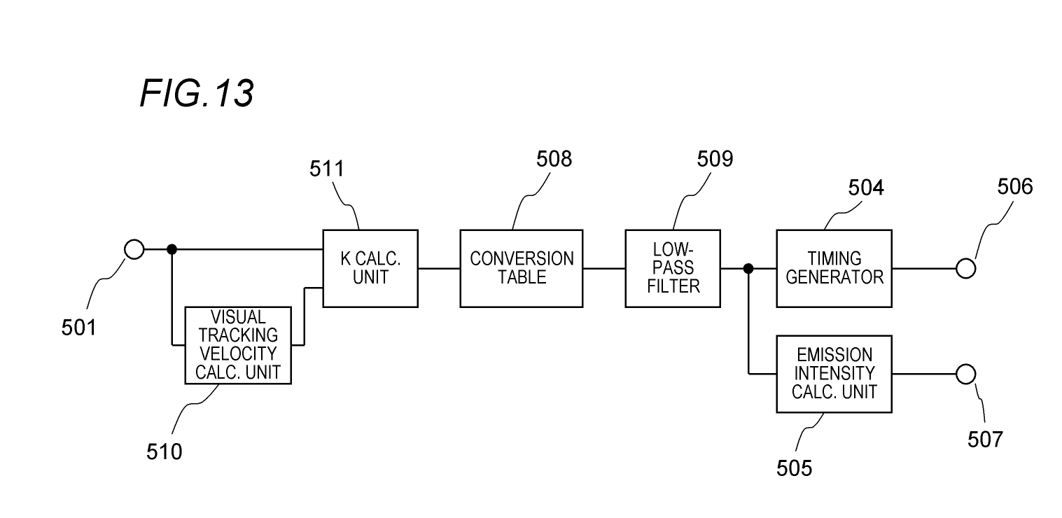

FIG. 13 illustrates a configuration example of an emission time calculation unit that performs evaluation of uniform velocity. An explanation of FIG. 13, which illustrates the same constituent blocks as in FIG. 10B, will be omitted. In FIG. 13, the reference numeral 510 is a visual tracking velocity calculation unit that computes the velocity (Xave) of the line of sight according to any one of the methods of Equation 5), Equation 6), Equation 8) or Equation 9) described above. The reference numeral 511 is a K calculation unit that calculates the offset coefficient K on the basis of line of sight velocity (Xave) and motion vector that are inputted. The reference numeral 508 is a conversion table in which, for instance, the characteristics illustrated in FIGS. 12A, 12B, 12C are stored in a look-up table format, and in which there is outputted an emission time for the offset coefficient K. The configuration and processing content of the low-pass filter 509, the timing generator 504 and the emission intensity calculation unit 505 are identical to those of FIG. 10B.

For the sake of a simpler explanation, only the offset coefficient in the X direction has been explained, but, preferably, the same evaluation is performed for the Y direction as well. When performing evaluation in the X direction and the Y direction, preferably, the emission time is shortened only if the offset coefficient in both directions is zero or sufficiently small. Preferably, for instance, emission times are obtained in both the X and Y directions, after which the longer emission time, from among the emission times calculated in the X and Y directions, is selected and used for backlight control. In FIG. 13, processing may take actually place in a dual X, Y system, up to the conversion table 508, such that the magnitudes of the emission times, which are the output of the conversion table 508, are compared to ascertain which is larger, and the greater value is inputted to the low-pass filter 509. Thereafter, processing may take place according to a single system.

The offset coefficient K obtained from Equation 1) and Equation 4) was set so as to be 0 when Xave is 0. When the visual tracking velocity (Xave, Yave) in the X direction and the Y direction are both 0, however, the subject is necessarily stationary, and hence it is evident that no hold blur occurs even if the emission time is lengthened. In this case, emission time is preferably lengthened in order to reduce flicker. In practice, the Xave+Yave value may be computed and if the result is equal to or smaller than a threshold value, it is decided that the subject is stationary, and the emission time, which is the output of the conversion table 508, is set forcibly to a maximum value.

(Uniform Acceleration Evaluation)

An example of uniform acceleration evaluation is described next.

FIG. 11B is a graph for explaining evaluation of uniform acceleration movement. In FIG. 11B, the ordinate axis represents points in time, and the abscissa axis represents velocity in the x direction. The ordinates Tₙ₋₂, Tₙ₋₁, Tₙ, Tₙ₊₁ denote points in time for each frame. In the explanation, the abscissa axis is the velocity in the x direction, but evaluation may be suitably performed for velocities in both the x and y axes. In FIG. 11B, the reference numerals 401a, 401b, 401c, 401d denote schematically the lines of sight of visual tracking at the respective points in time Tₙ₋₂, Tₙ₋₁, Tₙ, Tₙ₊₁. The reference numerals 402a, 402b, 402c, 402d denote the moving subject, which is moving at substantially uniform acceleration. The observer cannot match the line of sight to the motion of the subject, for each frame. Instead, the observer tracks the average motion of the subject and shifts the line of sight at uniform acceleration. That is, an offset (ΔV) with respect to the line of sight 401c arises for a subject, such as the subject 402c, that deviates from uniform acceleration. This velocity offset (ΔV) offset becomes a blur on the retina of the observer that is performing visual tracking at uniform acceleration. In turn, this blur gives rise to randomness feel in impulse display.

The character of this blur is defined in the present description in the form of an “offset coefficient: L” as the ratio of the extent to which the acceleration of the subject is offset with respect to the line of sight of visual tracking at uniform acceleration. Randomness feel is less likely to occur if this offset coefficient L takes on a small value. Accordingly, the backlight emission time is shortened, and there is performed display free of hold blur, close to that of impulse display.

The offset coefficient L is defined based on Equation 10), wherein An is the acceleration of the subject at an n-th frame, and Aave is the mean acceleration of the subject (i.e. mean acceleration of the line of sight along which the observer is performing visual tracking).

L=|An−Aave|/|Aave| Equation 10)

That is, the offset coefficient L is the ratio of the difference between the acceleration at the current point in time and the mean acceleration of the line of sight of the observer, with respect to the mean acceleration of the line of sight. When this ratio is 0, the motion of the line of sight of the observer is identical to that of the motion of the subject. Therefore, no randomness feel occurs even if the emission time in the backlight emission time is shortened, as in impulse display. In the case of an offset coefficient L of 0.5 or greater, by contrast, the subject is offset by a distance corresponding to a velocity that is half the velocity that has changed over one frame period during visual tracking. Disturbances start becoming conspicuous at such an offset coefficient. Accordingly, the backlight emission time is controlled on the basis of the value of the offset coefficient L. Specifically, control is performed so as to shorten the backlight emission time, and reduce hold blur, for blocks that have a small offset coefficient L and can be visually tracked. On the other hand, control is performed so as to lengthen the backlight emission time, and suppress the occurrence of randomness feel, for blocks that have a large offset coefficient L and that may give rise to randomness feel upon visual tracking.

The motion vector outputted by the motion detection unit 4 is a displacement amount per the time of one frame, i.e. is a velocity. Therefore, the acceleration at the current point in time can be obtained based on the difference between outputs of the motion detection unit 4. Equation 10) becomes

L=|{Xₙ−Xₙ₋₁}−Aave|/|Aave| Equation 11)

The mean acceleration can be obtained as

$$Aave = {\sum }_{m = 1}^{n - 1} ( {X}_{m} - {X}_{m - 1} ) / ( n - 1 ) \qquad Equation 12 )$$

The offset coefficient L is computed by substituting Equation 12) in Equation 11), and the backlight emission time of each block is decided on the basis of the magnitude of the offset coefficient L. The initial point in time in Equation 12) may be computed, for instance, taking a past scene change as a reference point.

In blocks where a subject is moving at uniform velocity, Aave is 0 and the denominator in Equation 10) and Equation 11) is 0. The observer can perform visual tracking when the subject is moving at uniform velocity. Hence, Equation 10) and Equation 11) are not computed in this case, and there is outputted a small value as the L value (for instance, L=0).

These computations are easy to implement in case of software processing, but may require greater hardware resources if implemented in the form of hardware. In hardware implementation, therefore, the computation of Equation 12) may involve computing the mean acceleration Aave of the line of sight through a computation (recursive filter) that is weighted based on the current point in time. Doing so allows reducing hardware requirements, and allows obtaining a value close to the acceleration of actual visual tracking by the observer. The equation for obtaining Aaveₙ, which is the acceleration of visual tracking during the frame at point in time n, is given by

Aaveₙ=S1·(Xₙ₋₁−Xₙ₋₂)+S2·Aaveₙ₋₁ Equation 13)

where

S1+S2=1 Equation 14)

The weighting of the acceleration of the line of sight one frame earlier and the acceleration of the subject one frame earlier can be modified using S1 and S2. Ordinarily, S1 and S2 are set in such a manner that S2 is greater than S1.

A computation such as the below-described one may be appropriately performed in order to compute the acceleration of the line of sight in an easy manner. The acceleration of the line of sight Aaveₙ in the frame at the point in time n may be obtained on the basis of an average value of the accelerations of the subject in the two immediately previous frames. Specifically,

Aaveₙ={(Xₙ₋₂−Xₙ₋₃)+(Xₙ₋₁−Xₙ₋₂)}/2 Equation 15)

To further simplify the computation of visual tracking acceleration, the acceleration of the subject Aaveₙ in the frame at the point in time n can be obtained simply on the basis of the acceleration of the subject in the two immediately previous frames. Specifically,

Aaveₙ=(Xₙ₋₁Xₙ₋₂) Equation 16)

The computation of the acceleration of the line of sight in Equation 15) and Equation 16) incurs some error, but is considerably advantageous in terms of the accompanying reduction in computational load, both in hardware and software.

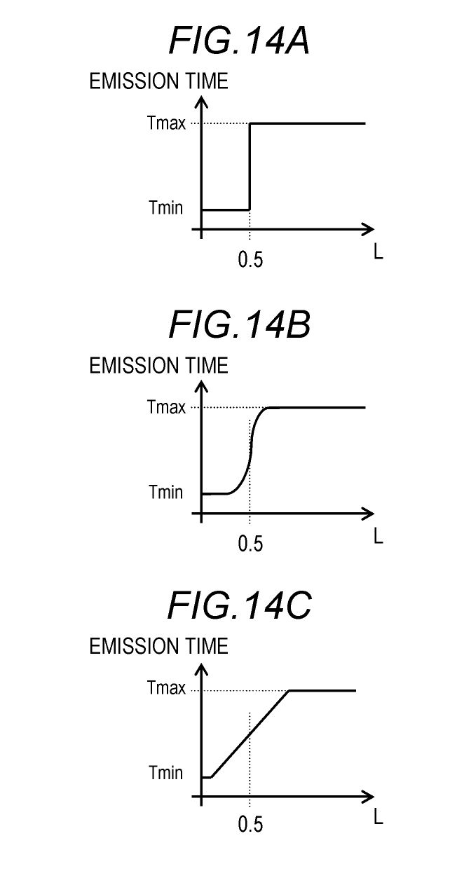

The offset coefficient L is computed by substituting Equation 12), Equation 13), Equation 15) or Equation 16) in Equation 11), and the backlight emission time of each block is decided on the basis of the magnitude of the offset coefficient L. A large offset arises between the line of sight and the subject if the value of the offset coefficient L is large. Therefore, offset between the line of sight and the subject is small if the emission time is long and the offset coefficient L is small. Accordingly, the emission time is set to be shorter, to minimize hold blur. FIGS. 14A, 14B, 14C illustrate examples of the relationship between a preferred backlight emission time with respect to the offset coefficient L. In all the conversion methods, the emission time becomes a minimum value Tmin when uniform acceleration movement is detected (when the offset coefficient L is zero or sufficiently small), and the emission time takes on the maximum value Tmax when motion is detected that is not uniform acceleration movement (offset coefficient L of some magnitude). Between Tmin and Tmax, the emission time increases monotonically, stepwise or continuously, in accordance with the offset amount (value of the offset coefficient L) from uniform velocity movement. In the conversion table of FIG. 14A, a first emission time Tmax is selected if the offset coefficient L is greater than a predetermined threshold (for instance, 0.5), and a short second emission time Tmin is selected if the offset coefficient L is equal to or smaller than the threshold. Such a method allows suppressing the occurrence of randomness feel, but may give rise to some discomfort upon emission time switching. Therefore, a more appropriate method involves modifying the emission time continuously, in accordance with the offset amount, from uniform acceleration movement, as illustrated in FIGS. 14B, 14C. FIGS. 14A, 14B, 14C are mere examples, and for instance the emission time may be lengthened from Tmin to Tmax over a plurality of stages.

(Emission Time Calculation Unit that Performs Evaluation Of Uniform Acceleration)

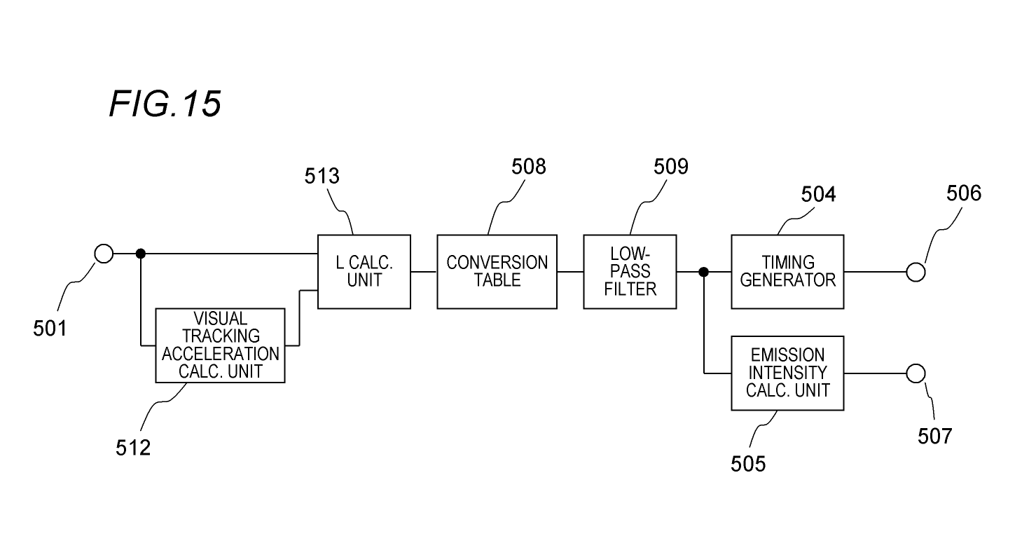

FIG. 15 illustrates a configuration example of an emission time calculation unit that performs evaluation of uniform acceleration. An explanation of FIG. 15, which illustrates the same constituent blocks as in FIG. 13, will be omitted. In FIG. 15, the reference numeral 512 is a visual tracking acceleration calculation unit that computes the acceleration (Aave) of the line of sight according to any one of the methods of Equation 12), Equation 13), Equation 15) or Equation 16) described above. The reference numeral 513 is an L calculation unit that calculates the offset coefficient L on the basis of the line of sight acceleration (Aave) and the motion vector that are inputted. The reference numeral 508 is a conversion table in which, for instance, the characteristics illustrated in FIGS. 14A, 14B, 14C are stored in a look-up table format, and in which there is outputted an emission time for the offset coefficient L. The configuration and processing content of the low-pass filter 509, the timing generator 504 and the emission intensity calculation unit 505 are identical to those of FIG. 10B.

For the sake of a simpler explanation, only the offset coefficient in X direction has been explained, but, preferably, the same evaluation is performed for the Y direction as well. When performing evaluation in the X direction and the Y direction, preferably, the emission time is shortened only if the offset coefficient in both directions is zero or sufficiently small. Preferably, for instance, emission times are obtained in both the X and Y directions, after which the longer emission time, from among the emission times calculated in the X and Y directions, is selected and used for backlight control. In FIG. 15, processing may take actually place in a dual X, Y system, up to the conversion table 508, such that the magnitudes of the emission times, which are the output of the conversion table 508, are compared to ascertain which is larger, and the greater value is inputted to the low-pass filter 509. Thereafter, processing may take place according to a single system.

Methods have been explained above in which the emission time of each block is decided on the basis of a uniform velocity evaluation and a uniform acceleration evaluation. These emission time determination methods are also effective when used singly. Suitable effects are elicited also when the two methods are used in combination. When using a combination of both methods, preferably, the emission time may be calculated independently according to each method, so that the backlight system is controlled using the longer emission time from among the calculated emission times. From among uniform velocity evaluation and uniform acceleration evaluation, the effect elicited by controlling the backlight emission time on the basis of a uniform velocity evaluation is greater than the effect elicited by controlling the backlight emission time on the basis of a uniform acceleration evaluation. Therefore, it is also appropriate to perform uniform velocity evaluation alone.

The first backlight control method and the second backlight control method may be combined. For instance, the backlight emission time of each block can be calculated in accordance with both methods, so that the backlight system is controlled using the longer emission time from among the calculated emission times. Alternatively, the presence or absence of motion for each block may be detected first in accordance with the first control method, and then the character of the motion (uniform velocity, uniform acceleration) may be evaluated in accordance with the second control method, for blocks where motion has been detected. That is, the emission time is lengthened for those blocks where no motion is detected (motion zero or sufficiently small), whereby flicker suppression takes precedence. The emission time is shortened for blocks where uniform (or near-uniform) velocity motion or uniform (or near-uniform) acceleration motion is detected, whereby improvement of hold blur takes precedence. For blocks where motion other than the above is detected, the emission time is rather lengthened to inhibit the occurrence of randomness feel, at the risk of incurring hold blur.

(Backlight Control Example)

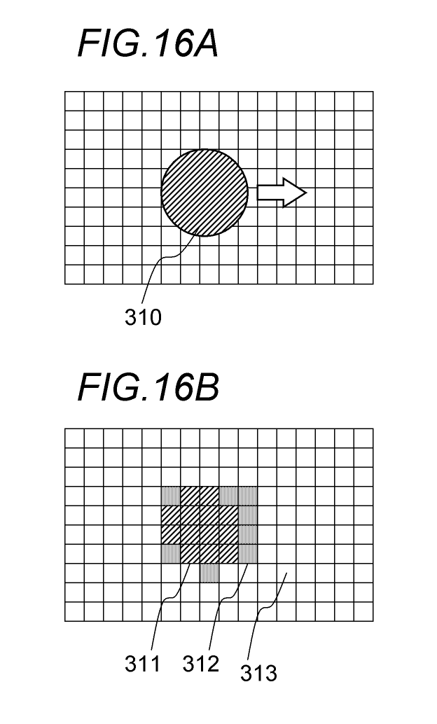

FIGS. 16A, 16B illustrate schematically an example of the results of backlight control for each block according to the first embodiment of the present invention.

In FIG. 16A the oblique hatching 310 denotes a subject that is moving at uniform velocity in the direction of the arrow, and the grid denotes backlight blocks. In FIG. 16B the oblique hatching portions 311 denote blocks having a short backlight emission time, the dotted portion 312 denotes blocks of intermediate backlight emission time, while plain blocks of reference numeral 313 denote blocks of long emission time. Thus, the backlight emission time is shortened at the video image portion in which the subject is moving, and is lengthened at the video image portion in which the subject is not moving.

(Advantages of the First Embodiment)

In the first embodiment of the present invention, as described above, motion in the video image is evaluated for each block, and the backlight emission time is controlled for each block in accordance with the evaluation result. At video image portions of significant motion, display such that in impulse display is performed through shortening of the backlight emission time. Occurrence of hold blur can be suppressed as a result. At video image portions of little motion, on the other hand, the backlight emission time is lengthened, so that occurrence of flicker is suppressed as a result. Thus, high-quality video reproduction is afforded in which both hold blur and flicker are suppressed, for video images where motion is significant, video image of little motion, and video images having mixed significant-motion portions and little-motion portions.

In the present embodiment, the emission intensity is controlled in accordance with the length of the emission time in such a manner that brightness is constant regardless of the length of the emission time. It becomes possible therefore to reduce brightness variability between blocks (i.e. to reduce jumps of brightness across block boundaries) that are caused by lengthening and shortening of emission time. In a case where emission time (and emission intensity) is switched continuously, for instance as illustrated in FIGS. 8B and 8C, it becomes possible to further reduce brightness variability between blocks having dissimilar motion vectors.

In the present embodiment, the timings of emission start and emission end are controlled in such a manner that the time centroid of the emission time does not deviate from a position established beforehand, regardless of the length of the emission time. This allows, as a result, equalizing the apparent frame display intervals (emission intervals), and allows preventing the motion of the subject from becoming unnatural and/or blurred.

In the present embodiment, there is evaluated the ease of visual tracking so that at video image portions of easy visual tracking, the backlight emission time is shortened and display such as that of impulse display is performed. As result, there can be realized high-quality video reproduction free of hold blur. At video image portions where visual tracking is difficult, by contrast, the backlight emission time is lengthened to elicit blur, so that the disturbance referred to as randomness feel can be prevented as a result.

### Second Embodiment

A second embodiment of the present invention will be explained next. Blurring at the time of imaging occurs as described above in a case where the imaging time of a video camera is long (in case of slow shutter speed). The blur at the time of imaging does not improve, even through shortening the backlight emission time, in the case of display of a video image signal that contains blur at the time of imaging. The second embodiment provides a method for improving blur at the time of imaging.

In the image display apparatus of the second embodiment, the backlight emission time is decided by evaluating the motion of a subject for each block, in the same way as in the image display apparatus of the first embodiment. Specifically, control is performed so as to shorten the emission time for blocks at which the subject is moving, to reduce hold blur. In the second embodiment, moreover, high emphasis processing is performed on the video image signal, for the direction of the motion vector that is the output of the motion detection unit 4. The blur at the time of imaging of the moving object is improved thereby, and both hold blur and blur at the time of imaging can be reduced as a result.

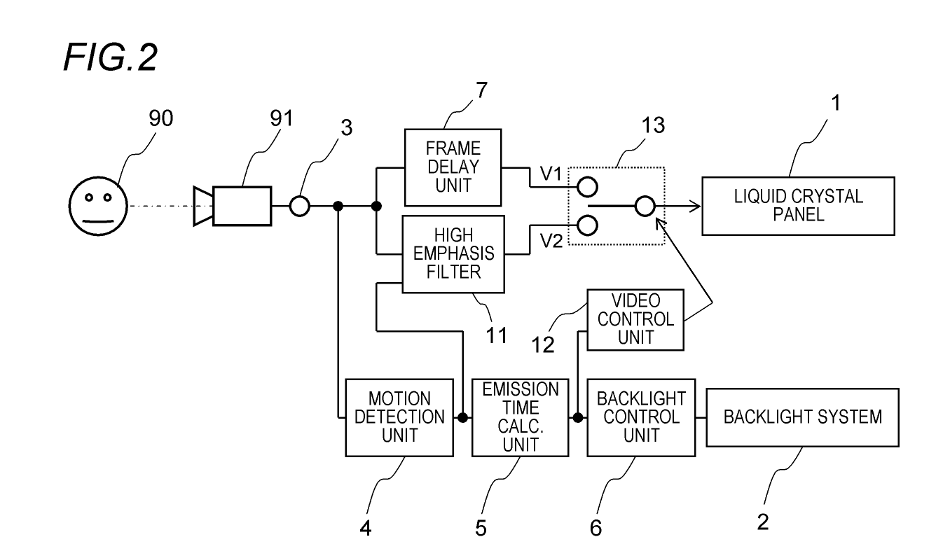

FIG. 2 illustrates a block diagram of the main portion of a driving circuit of the second embodiment of the present invention. Reference numerals in FIG. 2 that are identical to those of FIG. 1A of the first embodiment will not be explained. In FIG. 2, the reference numeral 11 is a motion direction high emphasis filter (blur reducing unit), the reference numeral 12 is a video control unit and the reference numeral 13 is a switch. Other portions operate according to the same configuration as in the first embodiment of FIG. 1A.

The motion detection unit 4 outputs a motion vector to the emission time calculation unit 5. As described above, the emission time calculation unit 5 performs control so as to shorten the emission time of the blocks for which motion (of uniform velocity or uniform acceleration) is detected. The video control unit 12 controls the switch 13 on the basis of the emission time calculated by the emission time calculation unit 5, and switches to a signal V2 when the emission time is short, and to a signal V1 when the emission time is long. The video image signal inputted to an input terminal 3 is imparted with a necessary time delay by the frame delay unit 7. The video image signal inputted to the input terminal 3 is inputted to the motion direction high emphasis filter 11, and is subjected to high emphasis processing for the motion direction, on the basis of the motion vector outputted by the motion detection unit 4. Blur at the time of imaging is reduced as a result of this filter processing. In the processing of the motion direction high emphasis filter 11, preferably, the filter characteristics are controlled on the basis of the magnitude and direction of the motion vector. Preferably, there is selected a spatial filter according to the direction of the motion vector, such that the high-frequency spatial frequency rise of the filter is modified in accordance with the magnitude of the motion vector. Blur at the time of imaging is significant when the motion vector is large. Therefore, the motion direction high emphasis filter 11 may perform emphasis from lower frequencies. The motion direction high emphasis filter 11 has preferably the same delay time as the frame delay unit 7. In the present embodiment, the filter that is used is changed in accordance with the direction of the subject motion, but the same filter (filter having no direction dependence) may be used, regardless of the direction of motion.

The switch 13 switches the signal V1 and the signal V2 in accordance with the emission time of each block in the backlight. The signal V2 in which blur at the time of imaging is cancelled is selected for blocks where motion is detected (blocks of short emission time Tmin), and the signal V2 is inputted to the liquid crystal panel 1. The display element (liquid crystal) is driven on the basis of the signal V2, and blur-free display is achieved as a result. In blocks where no motion is detected, or blocks where visual tracking is difficult (blocks of long emission time Tmax), the signal V1 is selected and inputted to the liquid crystal panel 1. The display element is driven on the basis of the signal V1, so that display faithful to the original (input video image) is achieved as a result.

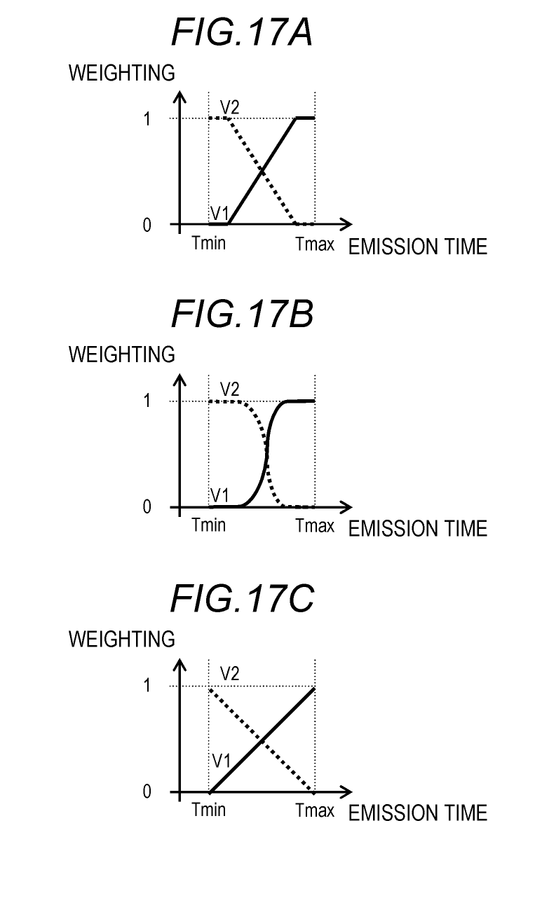

Upon switching between signals V1 and V2, the video image exhibits discontinuities that may cause discomfort to the observer. Therefore, switching between signals V1 and V2 is not done in either/or fashion but, preferably, there is a continuous change from signal V1 to V2 (or from V2 to V1). For instance, as illustrated in FIGS. 17A, 17B, 17C, weighting according to the emission time is set for the signals V1, V2, the signals V1 and V2 are weightedly added, and the result is outputted. Herein, the sum total of the weighting of the signals V1, V2 is preferably 1, since in that case brightness does not vary.

Preferably, the signals V1, V2 are data having a value that is proportional to brightness. In a case where a gamma-converted video image signal is inputted, preferably, reverse gamma conversion is performed on the input video image signal, the signal is then converted to data proportional to brightness, and the above processing is performed thereafter.

The second embodiment of the present invention described above allows reducing flicker in a video image portion of little motion, in the same way as in the first embodiment, and allows reducing hold blur in video image portions of significant motion. The disturbance referred to as randomness feel can also be prevented. Also, the liquid crystal panel is driven using the reduced-blur signal V2, or a combined signal of the original signal V1 and the signal V2, for blocks of short emission time. As a result there is achieved high-quality video display, having little blur, even when the video image signal contains blur at the time of imaging.

### Third Embodiment

An explanation follows next, in a third embodiment, of an example of a video image signal in a case of short imaging time (case where a high-speed electronic shutter is concomitantly used) of a video camera that captures a subject. No blur at the time of imaging occurs if the imaging time of the video camera is short. Upon display of such wholly blur-free video images in ordinary liquid crystal display apparatuses (of long backlight emission time), however, the motion of the subject may be perceived as a jittering awkward motion. In the liquid crystal display apparatus of the embodiments of the present invention, those blocks for which motion is detected are displayed over a short emission time. Therefore, such a problem is unlikely to occur. In the case of blocks for which a long emission time is set since there is little motion in the entirety of the block, however, there are rare instances where some of the blocks contain a subject of significant motion, and the above-described problem may then occur. A long emission time is set, and awkward motion is perceived, in the case of motion with difficult visual tracking. The third embodiment proposes a method for solving such problems.

In the image display apparatus of the third embodiment, the backlight emission time is decided by evaluating the motion of a subject for each block, in the same way as in the image display apparatus of the first embodiment. Specifically, the backlight emission time is lengthened for blocks where no motion is detected, and/or blocks for which motion of difficult visual tracking is detected, to generate hold blur thereby. In the third embodiment, moreover, low-pass filter processing is performed on the video image signal, for the direction of the motion vector which is the output of the motion detection unit 4. This allows, as a result, preventing awkward motion from being perceived, even if a moving subject is present among the blocks for which a long emission time is set.

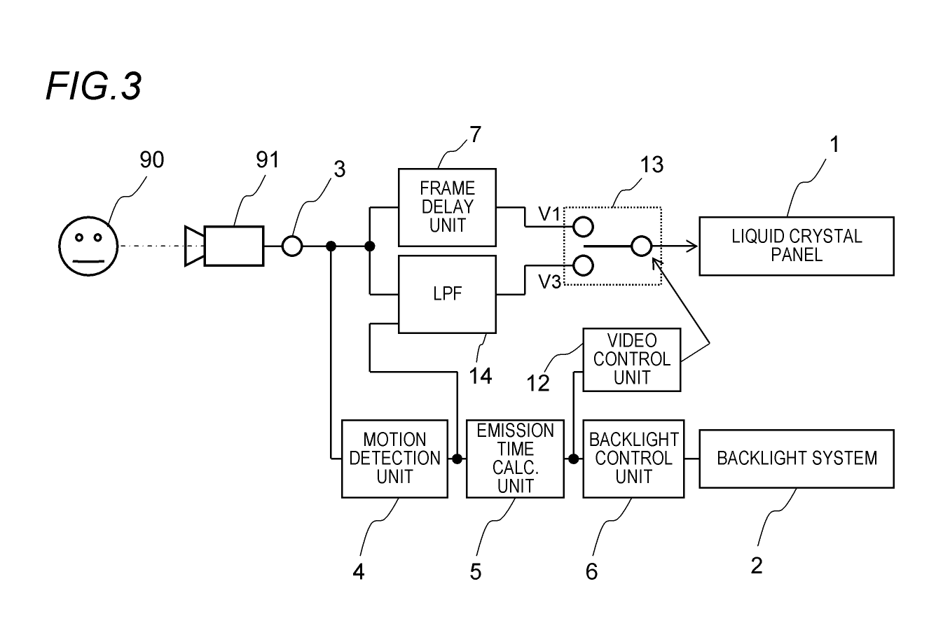

FIG. 3 illustrates a block diagram of the main portion of a driving circuit of the third embodiment of the present invention. Reference numerals in FIG. 3 that are identical to those of FIG. 1A of the first embodiment will not be explained. In FIG. 3, the reference numeral 12 is a video control unit, the reference numeral 13 is a switch and the reference numeral 14 is a motion direction low-pass filter (blur adding unit). Other portions operate according to the same configuration as in the first embodiment of FIG. 1A.

The motion detection unit 4 outputs a motion vector to the emission time calculation unit 5. As described above, the emission time calculation unit 5 performs control so as to shorten the emission time of the blocks for which motion (of uniform velocity or uniform acceleration) is detected. The video control unit 12 controls the switch 13 on the basis of the emission time calculated by the emission time calculation unit 5, and switches to a signal V1 when the emission time is short, and to a signal V3 when the emission time is long. The video image signal inputted to the input terminal 3 is imparted with a necessary time delay by the frame delay unit 7. The video image signal inputted to the input terminal 3 is inputted to the motion direction low-pass filter 14. Motion direction blur is added, in the low-pass filter processing, for the motion direction, based on the motion vector that is the output of the motion detection unit 4. In the processing of the motion direction low-pass filter 14, preferably, the filter characteristics are controlled on the basis of the magnitude and direction of the motion vector. Specifically, there is selected a spatial filter according to the direction of the motion vector, such that the high-frequency spatial frequency fall of the filter is modified in accordance with magnitude of the motion vector. Blur at the time of imaging is significant when the motion vector is large. Therefore, the motion direction low-pass filter 14 may attenuate the high-frequency signal based on a lower frequency. The motion direction low-pass filter 14 has preferably the same delay time as the frame delay unit 7. In the present embodiment, the filter that is used is modified in accordance with the direction of the subject motion, but the same filter (filter having no direction dependence) may be used, regardless of the motion direction.

The switch 13 switches the signal V1 and the signal V3 in accordance with the emission time of each block in the backlight. In blocks where motion is detected (blocks of short emission time Tmin), the signal V1 is selected and inputted to the liquid crystal panel 1. The display element is driven on the basis of the signal V1, and hence display with little blur is achieved. In blocks where no motion is detected, or blocks where visual tracking is difficult (blocks of long emission time Tmax), the signal V3, to which motion direction blur has been added by the motion direction low-pass filter 14, is selected and outputted to the liquid crystal panel 1. The display element is driven on the basis the signal V3, as a result of which there is achieved display in which pseudo-blur at the time of imaging is added to the moving subject. In order to eliminate discomfort upon switching between the signals V1 and V3, it is preferable to output a combined signal of the signals V1 and V3, weighted in accordance with the emission time, in the same way as explained in FIG. 17 for the second embodiment. Preferably, the signals V1, V3 are data having values that are proportional to brightness.

The third embodiment of the present invention described above allows reducing flicker in a video image portion of little motion, in the same way as in the first embodiment, and allows reducing hold blur in video image portions of significant motion. The disturbance referred to as randomness feel can also be prevented. Also, the signal V3 having blur added thereto, or a combined signal of the original signal V1 and the signal V3, is used for driving the liquid crystal panel, for blocks of long emission time. As a result, it becomes possible to suppress the occurrence of jittering awkward motion that is perceived in video image signals that are captured over a short imaging time.

### Fourth Embodiment

A fourth embodiment of the present invention is explained next.

In the fourth embodiment, the backlight emission time for each block is controlled based on an average value (APL: Average Picture Level) of the image data for each block. In the first through third embodiments, motion was evaluated for each block, and the emission time of each block was controlled based on differences in the way in which motion is perceived. In the fourth embodiment, the emission time of each block is controlled from the viewpoint of flicker.

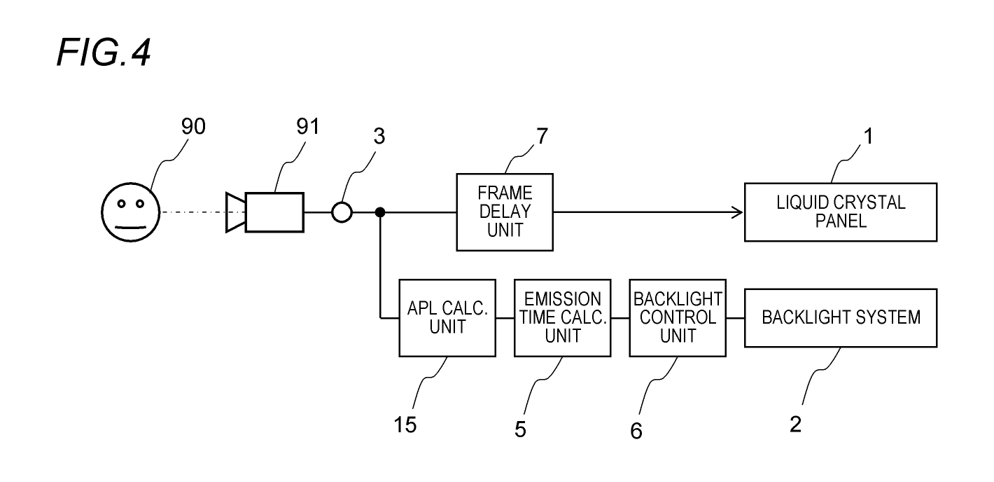

FIG. 4 illustrates a block diagram of the main portion of a driving circuit of the fourth embodiment. Reference numerals in FIG. 4 that are identical to those of FIG. 1A of the first embodiment will not be explained. In FIG. 4, the reference numeral 15 denotes an APL calculation unit that obtains an addition value (average value) of image data for each block. Other portions operate according to the same configuration as in the first embodiment of FIG. 1A.

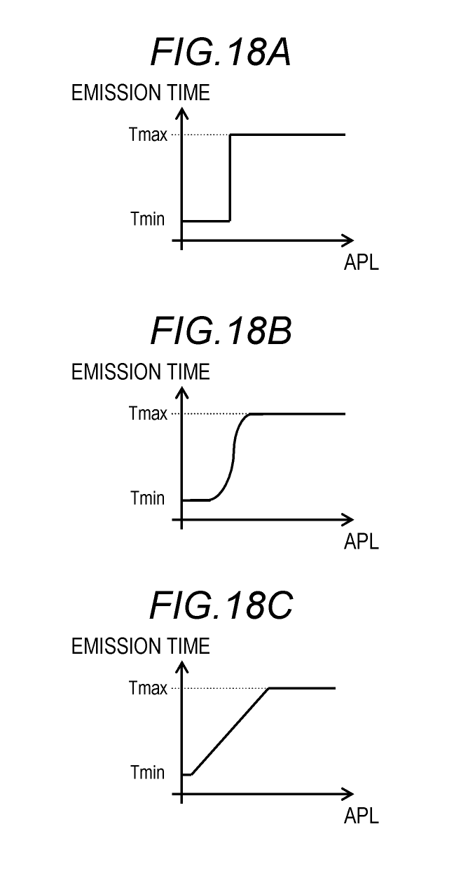

The APL calculation unit 15 adds image data of each block of the inputted video image signal, and outputs the resulting APL value to the emission time calculation unit 5. If APL is large, the emission time calculation unit 5 lengthens the emission time in order to reduce flicker. If the APL value is small, flicker is not conspicuous, and hence the emission time calculation unit 5 sets a short emission time, and outputs the emission time data to the backlight control unit. Other operations are identical to those of first embodiment, and hence an explanation thereof will be omitted. Preferably, the emission time calculation unit 5 obtains an emission time on the basis of an APL value by using a conversion table such as the one illustrated in, for instance, FIGS. 18A, 18B, 18C. FIG. 18A is an example wherein the emission time is shortened (Tmin) if the APL is equal to or smaller than a threshold, and the emission time is lengthened (Tmax) if the APL value is greater than the threshold. FIGS. 18B, 18C are examples in which the emission time varies continuously between Tmax and Tmin in accordance with the APL value.

The fourth embodiment of the present invention allows reducing flicker in video image portions where flicker is likely to be conspicuous (portion of large APL value), through adjustment of the emission time in accordance with the APL value. The fourth embodiment allows also improving hold blur at video image portions where flicker is inconspicuous (portions of small APL value). Thus, high-quality video reproduction is afforded in which both hold blur and flicker are suppressed, for any video images, i.e. bright video images, dark video images and mixed video images having bright portions and dark portions. Identical effects can be achieved if the motion detection unit 4 in the second and third embodiments described above is replaced by the APL calculation unit 15.

### Other Embodiments

In the above embodiments examples have been explained in which the image display apparatus is a transmissive direct-view AM-LCD. However, the invention is deemed to afford the same results in transmissive projector-type AM-LCDs and reflective projector-type AM-LCDs.

In the above embodiments, examples have been explained wherein emission intensity is controlled in such a manner that brightness (brightness feel) does not change depending on the length of emission time. However, it is also appropriate to combine techniques involving variable backlight emission time in response to video image motion, or in response to APL, with techniques, developed in recent years, of control of backlight emission intensity in blocks on the basis of image signals.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-224191, filed on Oct. 1, 2010, which is hereby incorporated by reference herein in its entirety.

What is claimed is:

1. An image display apparatus, comprising:
a liquid crystal panel;
a backlight system divided into a plurality of blocks relating to portions of a display screen of the liquid crystal panel, respectively; and
a control unit that controls light emission of each block of the backlight system,
wherein the control unit:
analyzes an inputted video image signal and detects motion in a video image to be displayed at each of the portions of the display screen corresponding to each of the plurality of blocks; and
controls emission time and emission intensity of each block in such a manner that in a block corresponding to a video image of little motion, the emission time is made relatively longer and the emission intensity is made relatively smaller, and in a block corresponding to a video image of significant motion, the emission time is made relatively shorter and the emission intensity is made relatively larger.

2. The image display apparatus according to claim 1,
wherein the control unit:
sets a first emission time, which is the longest emission time, for a block corresponding to a video image having no motion;
sets a second emission time, which is the shortest emission time, for a block corresponding to a video image in which motion greater than a threshold is detected; and
shortens the emission time between the first emission time and the second emission time, stepwise or continuously in accordance with a magnitude of motion.

3. The image display apparatus according to claim 1,
wherein the control unit controls the emission time of each block in such a manner that, in blocks corresponding to video images in which motion is detected, the emission time of a block corresponding to a video image in which motion of uniform velocity or uniform acceleration is detected is made relatively shorter, and the emission time of a block corresponding to a video image in which motion other than the motion of uniform velocity or uniform acceleration is detected is made relatively longer.

4. The image display apparatus according to claim 1,
wherein the control unit controls the backlight system in such a manner that time integrations of the emission intensity in each block are substantially identical to each other.

5. The image display apparatus according to claim 1,
wherein the control unit sets timings of emission start and emission end for each block in such a manner that a time centroid of the emission time weighted by the emission intensity does not change between frames.

6. The image display apparatus according to claim 1,
further comprising a blur reducing unit that reduces blur in the video image signal,
wherein the liquid crystal panel in a portion corresponding to a block for which the short emission time is set is driven using a video image signal in which blur has been reduced, or using a video image signal obtained by combining the inputted video image signal with a video image signal in which blur has been reduced.

7. The image display apparatus according to claim 1,
further comprising a blur adding unit that adds blur to the video image signal,
wherein the liquid crystal panel in a portion corresponding to a block for which the long emission time is set is driven using a video image signal to which blur has been added, or using a video image signal obtained by combining the inputted video image signal with a video image signal to which blur has been added.

8. An image display apparatus, comprising:
a liquid crystal panel;
a backlight system divided into a plurality of blocks relating to portions of a display screen of the liquid crystal panel, respectively; and
a control unit that controls light emission of each block of the backlight system,
wherein the control unit:
analyzes an inputted video image signal and detects motion in a video image to be displayed at each of the portions of the display screen corresponding to each of the plurality of blocks; and
controls emission time of each block in such a manner that the emission time in a block corresponding to a video image in which motion of uniform velocity or uniform acceleration is detected is made relatively shorter, and the emission time in a block corresponding to a video image in which motion other than the motion of uniform velocity or uniform acceleration is detected is made relatively longer.

9. The image display apparatus according to claim 8,
wherein the control unit:
calculates an offset between detected motion and motion of uniform velocity or uniform acceleration;
sets a first emission time, which is the longest emission time, for a block corresponding to a video image in which the offset is greater than a threshold;
sets a second emission time, which is the shortest emission time, for a block corresponding to a video image having no offset; and
lengthens the emission time between the first emission time and the second emission time, stepwise or continuously in accordance with a magnitude of the offset.

10. The image display apparatus according to claim 8,
wherein the control unit controls the backlight system in such a manner that time integrations of the emission intensity in each block are substantially identical to each other.

11. The image display apparatus according to claim 8,
wherein the control unit sets timings of emission start and emission end for each block in such a manner that a time centroid of the emission time weighted by the emission intensity does not change between frames.

12. The image display apparatus according to claim 8,
further comprising a blur reducing unit that reduces blur in the video image signal,
wherein the liquid crystal panel in a portion corresponding to a block for which the short emission time is set is driven using a video image signal in which blur has been reduced, or using a video image signal obtained by combining the inputted video image signal with a video image signal in which blur has been reduced.

13. The image display apparatus according to claim 8,
further comprising a blur adding unit that adds blur to the video image signal,
wherein the liquid crystal panel in a portion corresponding to a block for which the long emission time is set is driven using a video image signal to which blur has been added, or using a video image signal obtained by combining the inputted video image signal with a video image signal to which blur has been added.

14. A control method of an image display apparatus provided with a liquid crystal panel, and a backlight system with light emission, divided into a plurality of blocks relating to portions of a display screen of the liquid crystal panel, respectively, the method comprising the steps of:
analyzing an inputted video image signal, and detecting motion in a video image to be displayed at each of the portions of the display screen corresponding to each of the plurality of blocks; and
controlling emission time and emission intensity of each block in such a manner that in a block corresponding to a video image of little motion, the emission time is made relatively longer and the emission intensity is made relatively smaller, and in a block corresponding to a video image of significant motion, the emission time is made relatively shorter and the emission intensity is made relatively larger.
